(19) United States
(12) Patent Application Publication
(10) Pub. No.: US 2024/0120490 A1
(43) Pub. Date: Apr. 11, 2024

(54) ELECTRODE COMPOSITION, ELECTRODE SHEET FOR ALL-SOLID STATE SECONDARY BATTERY, AND ALL-SOLID STATE SECONDARY BATTERY, AND MANUFACTURING METHODS FOR ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Hideyuki SUZUKI, Kanagawa (JP)

(73) Assignee: FUJIFILM Corporation, Tokyo (JP)

(21) Appl. No.: 18/518,584

(22) Filed: Nov. 23, 2023

Related U.S. Application Data
(63) Continuation of application No. PCT/JP2022/026996, filed on Jul. 7, 2022.

(30) Foreign Application Priority Data
Jul. 7, 2021 (JP) 2021-113028

(51) Int. Cl. H01M 4/62; H01M 4/36; H01M 10/0562; H01M 10/058

(52) U.S. Cl. CPC H01M 4/622; H01M 4/366; H01M 10/0562; H01M 10/058; H01M 2004/021

(57) ABSTRACT

There is provided an electrode composition that contains an inorganic solid electrolyte, an active material, a conductive auxiliary agent, a polymer binder, and a dispersion medium and satisfies the following conditions (1) to (4). There are also provided an electrode sheet for an all-solid state secondary battery and an all-solid state secondary battery, as well as a method for producing these.
(1) The polymer binder is dissolved in the dispersion medium.
(2) The adsorption rate of the polymer binder with respect to the conductive auxiliary agent is more than 0% and 50% or less.
(3) The mass average molecular weight of the polymer that constitutes the polymer binder is 6,000 or more.
(4) The average particle diameter of the conductive auxiliary agent in the active material layer formed of the electrode composition is less than 1.0 μm.

### CROSS-REFERENCE TO RELATED APPLICATIONS

This application is a Continuation of PCT International Application No. PCT/JP2022/026996 filed on Jul. 7, 2022, which claims priority under 35 U.S.C. § 119 (a) to Japanese Patent Application No. 2021-113028 filed in Japan on Jul. 7, 2021. Each of the above applications is hereby expressly incorporated by reference, in its entirety, into the present application.

### BACKGROUND OF THE INVENTION

### 1. Field of the Invention

The present invention relates to an electrode composition, an electrode sheet for an all-solid state secondary battery, and an all-solid state secondary battery, and manufacturing methods for an electrode sheet for an all-solid state secondary battery and an all-solid state secondary battery.

### 2. Description of the Related Art

A secondary battery is a storage battery including a negative electrode, a positive electrode, and an electrolyte sandwiched between the negative electrode and the positive electrode, and it enables charging and discharging by the reciprocal migration of specific metal ions such as lithium ions between both electrodes.

As such a secondary battery, a non-aqueous electrolyte secondary battery using an organic electrolytic solution has been used in a wide range of use applications. However, research on an electrode, a material for forming the electrode, and the like is underway for the purpose of further improving battery performance such as rate characteristics. For example, JP2018-073687A describes a slurry that contains a conductive material, a conductive material, and a dispersing agent consisting of an ionic surfactant. It is described that in this slurry, a surface of an electrode active material is uniformly coated with a conductive material by using a dispersing agent consisting of an ionic surfactant. In addition, JP2017-188455A describes a solution for forming a coated positive electrode active material, which is a solution obtained by further mixing a conductive agent with a solution of a polymeric compound for coating containing a positive electrode active material powder, a polymeric compound for coating, and isopropanol.

However, in the non-aqueous electrolyte secondary battery using an organic electrolytic solution, liquid leakage easily occurs, and a short circuit easily occurs in the inside of the battery due to overcharging or overdischarging. As a result, there is a demand for additional improvement of safety and reliability.

Under these circumstances, an all-solid state secondary battery in which an inorganic solid electrolyte is used instead of the organic electrolytic solution has attracted attention. In this all-solid state secondary battery, a negative electrode, an electrolyte, and a positive electrode are all solid, and the safety or reliability of batteries including an organic electrolytic solution can be significantly improved. It is also said to be capable of extending the battery life. Further, the all-solid state secondary battery can have a structure in which the electrodes and the electrolyte are directly disposed in series. Therefore, the energy density can be further increased as compared to a non-aqueous electrolyte secondary battery in which an organic electrolytic solution is used, and the application to an electric vehicle or a large-sized storage battery is expected.

A constitutional layer of a secondary battery, irrespective of whether the secondary battery is a non-aqueous electrolyte secondary battery or an all-solid state secondary battery, generally is formed into a film by using a slurry composition obtained by dispersing or dissolving a material that forms the constitutional layer in a dispersion medium as described in JP2018-073687A and JP2017-188455A.

By the way, as substances that form constitutional layers (an active material layer, a solid electrolyte layer, and the like) of the all-solid state secondary battery, inorganic solid electrolytes, particularly an oxide-based inorganic solid electrolyte and a sulfide-based inorganic solid electrolyte have been in the limelight in recent years as electrolyte materials having a high ion conductivity comparable to that of the organic electrolytic solution, and research and development of all-solid state secondary batteries that utilize the characteristics of these inorganic solid electrolytes have been rapidly progressing. However, as a material that forms an active material layer (an active material layer forming material) of an all-solid state secondary battery, the material (the electrode composition) containing the above-described inorganic solid electrolyte, active material, conductive auxiliary agent, and the like has not been studied JP2018-073687A and JP2017-188455A.

### SUMMARY OF THE INVENTION

Constitutional layers of an all-solid state secondary battery are formed of solid particles (an inorganic solid electrolyte, an active material, a conductive auxiliary agent, and the like). Therefore, the interfacial contact state between solid particles and furthermore, the interfacial contact state between solid particles and a collector are restricted, and thus interface resistance tends to increase (ion conductivity tends to decrease). This increase in interface resistance causes not only an increase in battery resistance (a decrease in ion conductivity) of an all-solid state secondary battery but also a decrease in cycle characteristics of an all-solid state secondary battery.

The increase in resistance, which causes a decrease in battery performance, is due to not only the interfacial contact state of solid particles but also the non-uniform presence (the arrangement) of solid particles in the constitutional layer. Therefore, in a case where a constitutional layer is formed of a constitutional layer forming material, the constitutional layer forming material is required to have a characteristic (dispersion stability) of stably maintaining the dispersibility of the solid particles immediately after preparation.

Moreover, from the viewpoint of reducing the burden on the environment in recent years and reducing the manufacturing cost, the use of a high-concentration composition (a concentrated slurry) having an increased concentration of solid contents has been studied as a constitutional layer forming material. However, as the concentration of solid contents of the composition is increased, the characteristics of the composition generally deteriorate significantly. The same applies to the above-described dispersion stability and the like, and it is not easy to realize the required dispersion stability and the like in a high-concentration composition.

An object of the present invention is to provide an electrode composition having excellent dispersion stability even in a case where the concentration of solid contents is increased, where in a case of being used as an active material layer forming material of an all-solid state secondary battery, the electrode composition makes it possible to realize the suppression of the increase in battery resistance and the excellent cycle characteristics. In addition, another object of the present invention is to provide an electrode sheet for an all-solid state secondary battery and an all-solid state secondary battery, and manufacturing methods for an electrode sheet for an all-solid state secondary battery and an all-solid state secondary battery, in which the above electrode composition is used.

As a result of diligent studies on the electrode composition, the inventors of the present invention got an idea that although the improvement of the dispersion stability can be expected to some extent with respect to the inorganic solid electrolyte by improving a polymer binder or the like, in an electrode composition in which a conductive auxiliary agent having deteriorated dispersibility in a dispersion medium is present together, the overall improvement of the behavior of the polymer binder with respect to a conductive auxiliary agent in a dispersion medium leads to the improvement of dispersion stability. As a result of further carrying out studies based on this idea, the inventors of the present invention found that in a case where a polymer binder to be used in combination with solid particles is formed of a polymer having a specific molecular weight and in addition, a characteristic of being dissolved in a dispersion medium is imparted to the polymer binder, which is resultantly allowed to exhibit a proper affinity to exhibit a function of dispersing a conductive auxiliary agent in a dispersion medium as particles having a specific size, the electrode composition can have excellent dispersion stability even in a case where the concentration of solid contents is increased. In addition, it was found that in a case of using this electrode composition as an active material layer forming material, it is possible to manufacture an all-solid state secondary battery that is capable of realizing the suppression of the increase in battery resistance and the excellent cycle characteristics.

The present invention has been completed through further studies based on these findings.

That is, the above problems have been solved by the following means.

<1> An electrode composition comprising:
an inorganic solid electrolyte (SE) having an ion conductivity of a metal belonging to Group 1 or Group 2 of the periodic table;
an active material (AC);
a conductive auxiliary agent (CA);
a polymer binder (B); and
a dispersion medium (D),
in which the electrode composition satisfies the following conditions (1) to (4),
(1) the polymer binder (B) is dissolved in the dispersion medium (D),
(2) in the dispersion medium (D), an adsorption rate [A_{CA}] of the polymer binder (B) with respect to the conductive auxiliary agent (CA) is more than 0% and 50% or less,
(3) a mass average molecular weight of a polymer that constitutes the polymer binder (B) is 6,000 or more, and
(4) an average particle diameter of the conductive auxiliary agent (CA) that is present in an active material layer formed of the electrode composition is less than 1.0 μm.

<2> The electrode composition according to <1>, in which the adsorption rate [A_{CA}] is 5% or more and less than 30%.

<3> The electrode composition according to <1> or <2>, in which in the dispersion medium (D), an adsorption rate [A_{SE}] of the polymer binder (B) with respect to the inorganic solid electrolyte (SE) is 45% or less.

<4> The electrode composition according to any one of <1> to <3>, in which the mass average molecular weight is 10,000 to 700,000.

<5> The electrode composition according to any one of <1> to <4>, in which a difference ΔSP between an SP value of the dispersion medium (D) and an SP value of the polymer that constitutes the polymer binder (B) is 3.0 MPa^{1/2} or less.

<6> The electrode composition according to any one of <1> to <5>, in which the polymer that forms the polymer binder (B) contains a constitutional component having a functional group selected from the following group (a) of functional groups,

<Group (a) of Functional Groups>

a hydroxy group, an amino group, a carboxy group, a sulfo group, a phosphate group, a phosphonate group, a sulfanyl group, an ether bond, an imino group, an ester bond, an amide bond, a urethane bond, a urea bond, a heterocyclic group, an aryl group, and a carboxylic acid anhydride group.

<7> The electrode composition (SE) according to any one of <1> to <6>, in which the inorganic solid electrolyte is a sulfide-based inorganic solid electrolyte.

<8> An electrode sheet for an all-solid state secondary battery, comprising:
an active material layer formed of the electrode composition according to any one of <1> to <7>.

<9> The electrode sheet for an all-solid state secondary battery according to <8>, in which an average particle diameter of the conductive auxiliary agent (CA) in the active material layer is 0.5 μm or less.

<10> The electrode sheet for an all-solid state secondary battery according to <8> or <9>, in which an electron conductivity of the active material layer is 30 mS/cm or more.

<11> An all-solid state secondary battery comprising, in the following order:
a positive electrode active material layer;
a solid electrolyte layer; and
a negative electrode active material layer,
in which at least one layer of the positive electrode active material layer or the negative electrode active material layer is an active material layer formed of the electrode composition according to any one of <1> to <7>.

<12> A manufacturing method for an electrode sheet for an all-solid state secondary battery, the manufacturing method comprising:
forming a film of the electrode composition according to any one of <1> to <7>.

<13> A manufacturing method for an all-solid state secondary battery, the manufacturing method comprising:
manufacturing an all-solid state secondary battery through the manufacturing method according to <12>.

According to the present invention, it is possible to provide an electrode composition having excellent dispersion stability even in a case where the concentration of solid contents is increased, where in a case of being used as an active material layer forming material of an all-solid state secondary battery, the electrode composition makes it possible to realize the suppression of the increase in battery resistance and the excellent cycle characteristics. In addition, according to the present invention, it is possible to provide an electrode sheet for an all-solid state secondary battery and an all-solid state secondary battery, which have an active material layer formed of the above electrode composition. Further, according to the present invention, it is possible to provide manufacturing methods for an electrode sheet for an all-solid state secondary battery and an all-solid state secondary battery, in which the above electrode composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

### DESCRIPTION OF THE PREFERRED EMBODIMENTS

In the present invention, a numerical value range indicated using “to” means a range including numerical values before and after the “to” as the lower limit value and the upper limit value. In a case where a plurality of numerical value ranges are set and described for the content, physical properties, and the like of a component in the present invention, the upper limit value and the lower limit value, which form each of the numerical value ranges, are not limited to a specific combination described before and after “to” as a specific numerical value range and can be set to a numerical value range obtained by appropriately combining the upper limit value and the lower limit value of each numerical value range.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. In addition, a polymer binder (also simply referred to as a binder) means a binder composed of a polymer and includes a polymer itself and a binder constituted (formed) by containing a polymer.

In the present invention, a composition which contains an inorganic solid electrolyte, an active material, and a conductive auxiliary agent, as well as a polymer binder, and which is used as a material (an active material layer forming material) that forms an active material layer of an all-solid state secondary battery is referred to as an electrode composition (also referred to as an electrode composition for an all-solid state secondary battery). On the other hand, a composition which contains an inorganic solid electrolyte and a polymer binder as appropriate and which is used as a material that forms a solid electrolyte layer of an all-solid state secondary battery is referred to as an inorganic solid electrolyte-containing composition, where this composition generally does not contain an active material and the conductive auxiliary agent.

In the present invention, the electrode composition includes a positive electrode composition containing a positive electrode active material and a negative electrode composition containing a negative electrode active material. Therefore, any one of the positive electrode composition and the negative electrode composition, or collectively both of them may be simply referred to as an electrode composition, and any one of the positive electrode active material layer and the negative electrode active material layer, or collectively both of them may be simply referred to as an active material layer or an electrode active material layer. Further, in the present invention, any one of the positive electrode active material and the negative electrode active material, or collectively both of them may be simply referred to as an active material or an electrode active material.

[Electrode Composition]

The electrode composition according to the present invention contains an inorganic solid electrolyte (SE) having an ion conductivity of a metal belonging to Group 1 or Group 2 of the periodic table, an active material (AC), a conductive auxiliary agent (CA), a polymer binder (B), and a dispersion medium (D), where the electrode composition satisfies the conditions (1) to (4) described later. This electrode composition can stably maintain the excellent dispersibility (is excellent in the dispersion stability) that is obtained immediately after adjustment even in a case where the concentration of solid contents is increased after a lapse of time. In a case of using this electrode composition as an active material layer forming material, it is possible to form an active material layer that satisfies physical properties described later, and it is possible to realize an all-solid state secondary battery that exhibits the suppression of the increase in battery resistance and exhibits excellent cycle characteristics.

Although the details of the reason for the above are not yet clear, it is conceived to be as follows.

Due to the fact that the polymer binder (B) is composed of a polymer that is polymerized to have a molecular weight in the specific range (the condition (3)) and in addition, the polymer binder (B) is dissolved in the dispersion medium (D) (the condition (1)), the molecular chain of the polymer binder (B) spreads largely in the dispersion medium (D). In a case where such a polymer binder (B) is allowed to exhibit a proper adsorptivity (affinity) to the conductive auxiliary agent (CA) (the condition (2)), in the dispersion medium (D) and in the process of forming a film of the electrode composition, the polymer binder causes the adsorbed solid particles to repel with each other so that the (re)aggregation or sedimentation thereof is suppressed effectively, while suppressing excessive adsorption particularly to the conductive auxiliary agent (CA), whereby the conductive auxiliary agent can be made to be present as particles having an average particle diameter of 1 μm or less (the conditions (4)). Moreover, in the process of forming a film of the electrode composition, the solid particles in the active material layer can be brought into direct contact with each other, which makes it possible to sufficiently construct a conduction path (an electron conduction path or an ion conduction path) containing the conductive auxiliary agent (CA). In this way, it is possible to suppress an increase in the interfacial resistance between the solid particles as well as the resistance of the active material layer.

In a case of forming an active material layer by using such an electrode composition having excellent dispersion stability, it is possible to ensure the direct contact between the solid particles while suppressing the uneven distribution of the solid particles as well as the aggregation of the conductive auxiliary agent (CA) and the like. In particular, it is conceived that it is possible to enhance the dispersibility of the conductive auxiliary agent (CA) which is responsible for electron conductivity (it is possible to suppress the uneven distribution of the conductive auxiliary agent (CA) in the active material layer, thereby uniformly disposing the conductive auxiliary agent (CA)) and it is possible to realize excellent electron conductivity (the construction of the sufficient conduction path over the entire active material layer). Therefore, in an all-solid state secondary battery into which this active material layer is incorporated, overcurrent is hardly generated during charging and discharging while the battery resistance is suppressed to be low, and the deterioration of the solid particles is prevented, whereby excellent cycle characteristics are also exhibited.

It is conceived that in the electrode composition according to the present invention, the polymer binder (B) is adsorbed to at least the conductive auxiliary agent (CA) as described above and is also adsorbed to the inorganic solid electrolyte (SE) and the active material (AC) as appropriate, thereby being interposed between the solid particles to exhibit a function of dispersing solid particles such as the conductive auxiliary agent (CA) in the dispersion medium (D). Here, the adsorption of the polymer binder (B) to the solid particles is not particularly limited; however, it includes not only physical adsorption but also chemical adsorption (adsorption by chemical bond formation, adsorption by transfer of electrons, or the like).

On the other hand, the polymer binder (B) functions in the active material layer as a binding agent that binds the solid particles. In addition, it may also function as a binding agent that binds a collector to solid particles.

As described above, the electrode composition according to the embodiment of the present invention satisfies the following conditions (1) to (4). Each of the conditions can also be said to be a condition that is satisfied by the polymer binder (B) with respect to solid particles of the inorganic solid electrolyte (SE), the active material (AC), and the conductive auxiliary agent (CA), as well as the dispersion medium (D).

Hereinafter, each of the conditions will be described.

Condition (1): The polymer binder (B) is dissolved in the dispersion medium (D).

The polymer binder (B) contained in the electrode composition according to the embodiment of the present invention exhibits characteristics (solubility) of being soluble in the dispersion medium (D). The polymer binder (B) in the electrode composition generally is present in a state of being dissolved in the dispersion medium (D) in the electrode composition, which depends on the content of the dispersion medium (D).

In a case where the condition (1) is combined with the conditions (2) to (4) in the electrode composition containing the above components, the molecular chain (molecular structure) of the polymer (b) that constitutes the polymer binder (B) in the dispersion medium (D) spreads, and the solid particles that have adsorbed or are present adjacent thereto are allowed to repel with each other, whereby the aggregation or the like can be effectively suppressed. As a result, it is possible to realize not only the excellent initial dispersibility but also the high dispersion stability of the electrode composition.

In the present invention, the solubility of the polymer binder (B) in the dispersion medium (D) can be appropriately imparted by the kind (the structure and the composition of the polymer chain) of the polymer (b) that forms the polymer binder (B), the mass average molecular weight of the polymer (b), and the kind of the functional group selected from the group (a) of functional groups described later or the content of the functional group, as well as the combination with the dispersion medium (D) (for example, the difference in SP value described later) and the like.

In the present invention, the description that the polymer binder is dissolved in a dispersion medium means that a polymer binder is dissolved in a dispersion medium of the electrode composition, and for example, it means that the solubility is 10% by mass or more in the solubility measurement. On the other hand, the description that the polymer binder is not dissolved (is insoluble) in a dispersion medium means that the solubility in the solubility measurement is less than 10% by mass.

The measuring method for solubility is as follows. That is, a specified amount of a polymer binder serving as a measurement target is weighed in a glass bottle, 100 g of a dispersion medium that is the same kind as the dispersion medium contained in the electrode composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the polymer binder dissolved (the above-described specified amount), and the upper limit concentration X (% by mass) at which the transmittance is 99.8% is defined as the solubility of the polymer binder in the above dispersion medium.

<Transmittance Measurement Conditions>

Dynamic light scattering (DLS) measurement

Device: DLS measuring device DLS-8000 manufactured by Otsuka Electronics Co., Ltd.

Laser wavelength, output: 488 nm/100 mW

Sample cell: NMR tube

Condition (2): In the dispersion medium (D), an adsorption rate [A_{CA}] of the polymer binder (B) with respect to the conductive auxiliary agent (CA) is more than 0% and 50% or less.

In a case where the condition (2) is combined with other conditions in the electrode composition containing the above components, the excessive adsorption of the polymer binder (B) to the conductive auxiliary agent (CA) is suppressed, whereby the initial dispersibility and dispersion stability (collectively referred to as dispersion characteristics) of the conductive auxiliary agent (CA) are improved, and it is also possible to sufficiently construct the electron conduction path. In terms of improving the dispersion characteristics, the adsorption rate [A_{CA}] is preferably 2% or more, more preferably 5% or more, and still more preferably 10% or more. On the other hand, in terms of achieving both the dispersion characteristics and the construction of the electron conduction path at a high level, the upper limit of the adsorption rate [A_{CA}] is preferably 40% or less, more preferably less than 30%, and still more preferably 25% or less.

In the present invention, the adsorption rate [A_{CA}] with respect to the conductive auxiliary agent (CA) can be appropriately set depending on the kind (the structure and the composition of the polymer chain) of the polymer (b) that forms the polymer binder (B), the mass average molecular weight of the polymer (b), the kind of the functional group selected from the group (a) of functional groups described later or the content of the functional group, the surface state of the conductive auxiliary agent (CA), and the like.

The adsorption rate [A_{CA}] is a value measured by using the conductive auxiliary agent (CA), the polymer binder (B), and the dispersion medium (D), which are contained in the electrode composition, and it is an indicator that indicates the degree of adsorption of the polymer binder (B) with respect to the conductive auxiliary agent (CA) in the dispersion medium (D). Here, the adsorption of the polymer binder to the conductive auxiliary agent includes not only physical adsorption but also chemical adsorption (adsorption by chemical bond formation, adsorption by transfer of electrons, or the like).

In a case where the electrode composition contains a plurality of kinds of conductive auxiliary agents, the adsorption rate shall be an adsorption rate with respect to a conductive auxiliary agent having the same composition as the conductive auxiliary agent (in terms of kind and content) in the electrode composition. Similarly, also in a case where the electrode composition contains a plurality of kinds of dispersion media, the adsorption rate shall be an adsorption rate in a case where a dispersion medium having the same composition as the dispersion media (in terms of kind and content) in the electrode composition is contained. In addition, also in a case where the electrode composition contains a plurality of kinds of polymer binders (B), the adsorption rate shall be an adsorption rate in the case where the plurality of kinds of polymer binders are contained.

The adsorption rate [A_{CA}] (%) is a value measured as follows.

That is, the polymer binder (B) is dissolved in the dispersion medium (D) to prepare a binder solution having a concentration of 1% by mass. The binder solution and the conductive auxiliary agent (CA) are placed in a vial of 15 ml at a proportion such that the mass ratio of the polymer binder (B) in this binder solution to the conductive auxiliary agent (CA) is 3:1, and stirred for 1 hour with a mix rotor at room temperature (25° C.) and a rotation speed of 80 rpm, followed by being allowed to stand. The supernatant obtained by solid-liquid separation was filtered through a filter having a pore diameter of 1 μm, and the entire amount of the obtained filtrate has been dried to be solid, and then the mass W_{pA} of the polymer binder (B) remaining in the filtrate (the mass of the polymer binder (B) that has not adsorbed to the conductive auxiliary agent (CA)) is measured. From this mass W_{PA} and the mass W_{PB} of the polymer binder (B) contained in the binder solution used for the measurement, the adsorption rate of the polymer binder (B) with respect to the conductive auxiliary agent (CA) is calculated according to the following expression. The average value of the adsorption rates obtained by carrying out this operation twice is defined as the adsorption rate [A_{CA}] (%).

Adsorption rate (%)=[(W_{PB}−W_{PA})/W_{PB}]×100

Condition (3): The mass average molecular weight of the polymer (b) that constitutes the polymer binder (B) is 6,000 or more.

In a case where the condition (3) is combined with other conditions in the electrode composition containing the above components, the molecular chain (molecular structure) of the polymer (b) spreads largely in the dispersion medium (D), and thus the aggregation of the solid particles is effectively suppressed, whereby the dispersion characteristics can be further enhanced. From the viewpoint that further improvement of dispersion characteristics can be realized, the mass average molecular weight of the polymer is preferably 7,000 or more, more preferably 10,000 or more, still more preferably 50,000 or more, and particularly preferably 200,000 or more. On the other hand, the mass average molecular weight can be set to 2,000,000 or less, and it is preferably 1,000,000 or less, more preferably 700,000 or less, and still more preferably 600,000 or less, from the viewpoint that excessive coating of the surface of the solid particles is suppressed and sufficient conduction paths can be constructed.

The mass average molecular weight of the polymer (b) can be appropriately adjusted by changing the kind, content, polymerization time, polymerization temperature, and the like of the polymerization initiator.

—Measurement of Molecular Weight—

In the present invention, unless specified otherwise, molecular weights of a polymer and a macromonomer refer to a mass average molecular weight and number average molecular weight in terms of standard polystyrene conversion, which are determined by gel permeation chromatography (GPC). The measurement method thereof includes, basically, a method in which conditions are set to the following measurement condition 1 or the following measurement condition 2 (which is preferential). However, depending on the kind of polymer or macromonomer, an appropriate eluent may be suitably selected and used.

(Measurement Condition 1)

Column: Two columns of TOSOH TSKgel Super AWM-H (product name, manufactured by Tosoh Corporation) are connected.

Carrier: 10 mM LiBr/N-methylpyrrolidone

Measurement temperature: 40° C.

Carrier flow rate: 1.0 ml/min

Sample concentration: 0.1% by mass

Detector: refractive index (RI) detector

(Measurement Condition 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation) is used.

Carrier: tetrahydrofuran

Measurement temperature: 40° C.

Carrier flow rate: 1.0 ml/min

Sample concentration: 0.1% by mass

Detector: refractive index (RI) detector

Condition (4): The average particle diameter of the conductive auxiliary agent (CA) that is present in an active material layer formed of the electrode composition is less than 1.0 μm.

In a case where the active material layer is formed of the electrode composition according to the present invention, the condition (4) means that the average particle diameter of the conductive auxiliary agent (CA) present in this active material layer is less than 1.0 μm. In a case where the condition (4) is combined with other conditions in the electrode composition containing the above components, the direct contact between the solid particles in the active material layer can be achieved, which makes it possible to sufficiently construct the electron conduction path containing the conductive auxiliary agent.

The average particle diameter of the conductive auxiliary agent (CA) in the condition (4) shall be a value that is measured according to a method described in <Evaluation 3: Average particle diameter of conductive auxiliary agent in active material layer> in Examples described later. It is noted that the forming conditions for the active material layer are not particularly limited, and examples thereof include the conditions that are described in the section of “Formation (film formation) of each layer” described later, for example, the production conditions for each electrode sheet in Examples.

From the viewpoint of further improving dispersion characteristics and constructing the electron conduction path, the average particle diameter of the conductive auxiliary agent (CA) is preferably 0.8 μm or less, more preferably 0.6 μm or less, and still more preferably 0.5 m or less. The lower limit of the average particle diameter is not particularly limited; however, for example, it is practically 0.05 μm and is preferably 0.1 μm or more. It is noted that one of the preferred forms thereof is also to adopt “the average particle diameter of the conductive auxiliary agent (CA)” in the electrode sheet for an all-solid state secondary battery according to the present invention, which will be described later.

The average particle diameter of the conductive auxiliary agent (CA) can be appropriately adjusted by changing the particle diameter, content, surface state, or the like of the conductive auxiliary agent (CA) to be used, as well as the kind of the dispersion medium or the polymer binder (for example, the adjustment of the difference between the SP values), the content of the polymer binder, and the like. For example, in a case where the content of the conductive auxiliary agent (CA) is increased, the average particle diameter tends to be large. In addition, in a case where the content of the polymer binder is increased, the average particle diameter tends to be small.

In a case of setting, for the condition (4), the average particle diameter of the conductive auxiliary agent (CA) to be less than 1.0 μm (the condition (4A)) in a dispersion liquid prepared by mixing the polymer binder (B), the dispersion medium (D), and the conductive auxiliary agent (CA), where the kinds and mass proportions thereof are the same as those in the electrode composition, the dispersion characteristics of the conductive auxiliary agent (CA) in the electrode composition are improved, and the condition (4) can be realized.

The average particle diameter of the conductive auxiliary agent (CA) in the condition (4A) is the average particle diameter which is measured regarding a dispersion liquid that is obtained by separate mixing using the polymer binder (B), the dispersion medium (D), and the conductive auxiliary agent (CA), which are contained in the electrode composition, at the same mass proportion (content) as the content in the electrode composition. In a case of using such a separately prepared dispersion liquid as a measurement target, it is possible to evaluate, in the dispersion medium (D), the dispersibility of the polymer binder (B) with respect to the conductive auxiliary agent (CA). The average particle diameter of the conductive auxiliary agent (CA) in the above-described dispersion liquid shall be a value measured according to a method described in Examples described later. The preferred range of the average particle diameter in the condition (4A) is the same as the above-described range in the condition (4).

The electrode composition according to the embodiment of the present invention is preferably a slurry in which the inorganic solid electrolyte (SE), the active material (AC), and the conductive auxiliary agent (CA) are dispersed in a dispersion medium (D), particularly a high-concentration slurry.

The concentration of solid contents of the electrode composition according to the embodiment of the present invention is not particularly limited and can be appropriately set to, for example, 20% to 80% by mass at 25° C. The concentration of solid contents is preferably 30% to 75% by mass and more preferably 40 to 70% by mass.

Since the electrode composition according to the embodiment of the present invention exhibits excellent dispersion characteristics, it is possible to obtain a high-concentration composition (slurry) in which the concentration of solid contents is set to be high as compared in the related art as the electrode composition. For example, the lower limit value of the concentration of solid contents of the high-concentration composition can be set to 50% by mass or more at 25° C. and can also be set to, for example, 60% by mass or more. The upper limit value thereof is less than 100% by mass and can be set to, for example, 90% by mass or less. It is preferably 85% by mass or less and more preferably 80% by mass or less.

In the present invention, the solid content (solid component) refers to components that neither volatilize nor evaporate and disappear in a case where the electrode composition is subjected to drying treatment at 150° C. for 6 hours in a nitrogen atmosphere at a pressure of 1 mmHg. Typically, the solid content refers to a component other than the dispersion medium (D) described later. In addition, the content in the total solid content indicates the content in 100% by mass of the total mass of the solid content.

The electrode composition according to the embodiment of the present invention is preferably a non-aqueous composition. In the present invention, the non-aqueous composition includes not only an aspect including no watery moisture but also an aspect where the water content (also referred to as the “watery moisture content”) is preferably 500 ppm or less. In the non-aqueous composition, the water content is more preferably 200 ppm or less, still more preferably 100 ppm or less, and particularly preferably 50 ppm or less. In a case where the electrode composition is a non-aqueous composition, it is possible to suppress the deterioration of the inorganic solid electrolyte. The water content refers to the amount of water (the mass proportion thereof to the electrode composition) in the electrode composition and specifically is a value measured by Karl Fischer titration after filtering the solid electrolyte composition through a membrane filter having a pore size of 0.02 μm.

Due to having excellent characteristics described above, the electrode composition according to the embodiment of the present invention can be preferably used as a material that forms an active material layer of an electrode sheet for an all-solid state secondary battery and an all-solid state secondary battery. In particular, it can be preferably used as a material that forms a positive electrode active material layer or a material that forms a negative electrode active material layer containing a negative electrode active material having a large expansion and contraction due to charging and discharging.

Hereinafter, the components that are included in the electrode composition according to the embodiment of the present invention and components that may be included therein will be described.

<Inorganic Solid Electrolyte (SE)>

The electrode composition of the embodiment of the present invention contains the inorganic solid electrolyte (SE).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte contained in the electrode composition according to the embodiment of the present invention, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

In a case where the all-solid state secondary battery according to the embodiment of the present invention is a lithium ion battery, the inorganic solid electrolyte preferably has a lithium ion conductivity.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In Formula (S1), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphization method.

Examples of the amorphization method include a mechanical milling method, a solution method, and a melting quenching method. This is because treatments at a normal temperature become possible, and it is possible to simplify manufacturing processes.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑ₎M^{ee}ₓₑD^{ee}O (xe represents a number of 0 or more and 0.1 or less, M^{ee} represents a divalent metal atom, and D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable. In a case where the inorganic solid electrolyte has a particle shape, the particle diameter (volume average particle diameter: D₅₀) of the inorganic solid electrolyte is not particularly limited; however, it is preferably 0.01 μm or more, more preferably 0.1 μm or more, and still more preferably 0.5 μm or more. The upper limit thereof is preferably 100 μm or less, more preferably 50 μm or less, and still more preferably 10 μm or less.

The particle diameter of the inorganic solid electrolyte is measured according to the following procedure. Using water (heptane in a case where the inorganic solid electrolyte is unstable in water), the particles of the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Using this dispersion liquid sample, data collection is carried out 50 times by using a laser scattering-type particle size distribution analyzer LA-920 (product name, manufactured by Horiba Ltd.) and using a quartz cell for measurement at a temperature of 25° C. to obtain the volume average particle diameter. Other detailed conditions and the like can be found in Japanese Industrial Standards (JIS) Z8828: 2013 “Particle Diameter Analysis-Dynamic Light Scattering Method” as necessary. Five samples per level are produced and measured, and the average values thereof are employed.

The method of adjusting the particle diameter is not particularly limited, and a known method can be applied. Examples thereof include a method using a normal pulverizer or a classifier. As the pulverizer or a classifier, for example, a mortar, a ball mill, a sand mill, a vibration ball mill, a satellite ball mill, a planetary ball mill, a swirling airflow-type jet mill, or a sieve is suitably used. During pulverization, it is possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

The inorganic solid electrolyte contained in the electrode composition may be one kind or two or more kinds.

The content of the inorganic solid electrolyte in the electrode composition is not particularly limited and is appropriately determined. From the viewpoint of dispersion characteristics, it is preferably 50% by mass or more, more preferably 70% by mass or more, and particularly preferably 90% by mass or more, in 100% by mass of the solid content in terms of the total with the active material. From the same viewpoint, the upper limit thereof is preferably 99.9% by mass or less, more preferably 99.5% by mass or less, and particularly preferably 99% by mass or less.

<Active Material (AC)>

The electrode composition according to the embodiment of the present invention contains an active material capable of intercalating and deintercalating ions of a metal belonging to Group 1 or Group 2 in the periodic table.

Examples of the active material (AC) include a positive electrode active material and a negative electrode active material.

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element Mb (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃(lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The positive electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable. In a case where the positive electrode active material has a particle shape, the particle diameter (volume average particle diameter) of the positive electrode active material is not particularly limited; however, it is, for example, preferably 0.1 to 50 μm and more preferably 0.5 to 10 μm. The particle diameter of the positive electrode active material particle can be adjusted in the same manner as in the preparation of the particle diameter of the inorganic solid electrolyte, and the particle diameter thereof can be measured by the same measuring method as the measuring method for the particle diameter of the inorganic solid electrolyte.

A positive electrode active material obtained using a baking method may be used after being washed with water, an acidic aqueous solution, an alkaline aqueous solution, or an organic solvent.

The positive electrode active material contained in the electrode composition according to the present invention may be one kind or two or more kinds.

The content of the positive electrode active material in the electrode composition is not particularly limited and is appropriately determined. For example, it is preferably 10% to 97% by mass, more preferably 30% to 95% by mass, still more preferably 40% to 93% by mass, and particularly preferably 50% to 90% by mass in 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 200 to 400 in terms of 20 value in case of being measured by an X-ray diffraction method using CuKα rays, and the oxide may have a crystalline diffraction line. The highest intensity in a crystalline diffraction line observed in a range of 400 to 700 in terms of 20 value is preferably 100 times or less and more preferably 5 times or less with respect to the intensity of a diffraction line at the apex in a broad scattering band observed in a range of 200 to 400 in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume change during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is an alloy that is usually used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is usually used as a negative electrode active material for a secondary battery. Such an active material has a large expansion and contraction due to charging and discharging of the all-solid state secondary battery and accelerates the deterioration of cycle characteristics. However, since the electrode composition according to the embodiment of the present invention contains the above components and satisfies each of the above conditions, the deterioration of the cycle characteristics can be suppressed. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon element-containing alloy (for example, LaSi₂, VSi₂, La—Si, Gd—Si, or Ni—Si) including a silicon material such as Si or SiOₓ (0<x<1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOₓ itself can be used as a negative electrode active material (a metalloid oxide) and Si is produced along with the operation of an all-solid state secondary battery, SiOₓ can be used as a negative electrode active material (or a precursor material thereof) capable of being alloyed with lithium.

Examples of the negative electrode active material including the tin element include Sn, SnO, SnO₂, SnS, SnS₂, and the above-described active material including the silicon element and the tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is still more preferable to include a negative electrode active material containing silicon (Si) or a silicon-containing alloy.

The negative electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable. In a case where the negative electrode active material has a particle shape, the particle diameter (volume average particle diameter) of the negative electrode active material is not particularly limited; however, it is, for example, preferably 0.1 to 60 μm and more preferably 0.5 to 10 μm. The particle diameter of the negative electrode active material particle can be adjusted in the same manner as in the preparation of the particle diameter of the inorganic solid electrolyte, and the particle diameter thereof can be measured by the same measuring method as the measuring method for the average particle diameter of the inorganic solid electrolyte.

The negative electrode active material contained in the electrode composition according to the embodiment of the present invention may be one kind or two or more kinds.

The content of the negative electrode active material in the electrode composition is not particularly limited and is appropriately determined. For example, it is preferably 10% to 90% by mass, more preferably 20% to 85% by mass, still more preferably 30% to 80% by mass, and even still more preferably 40% to 75% by mass in 100% by mass of the solid content.

The chemical formulae of the compounds obtained by the above baking method can be calculated using an inductively coupled plasma (ICP) emission spectroscopy as a measuring method from the mass difference of powder before and after baking as a convenient method.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent (CA)>

The electrode composition according to the embodiment of the present invention contains a conductive auxiliary agent.

The conductive auxiliary agent is not particularly limited, and a conductive auxiliary agent that is known as an ordinary conductive auxiliary agent can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The conductive auxiliary agent contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable. In a case where the conductive auxiliary agent has a particle shape, the particle diameter (volume average particle diameter) of the conductive auxiliary agent is not particularly limited; however, it is, for example, preferably 0.02 to 1.0 μm, more preferably 0.02 μm or more and less than 1.0 μm, and still more preferably 0.03 to 0.5 μm. The particle diameter of the conductive auxiliary agent can be adjusted in the same manner as in the adjustment of the particle diameter of the inorganic solid electrolyte, and the particle diameter thereof can be measured by the same measuring method as the method for the average particle diameter of the inorganic solid electrolyte.

The conductive auxiliary agent contained in the electrode composition according to the embodiment of the present invention may be one kind or two or more kinds.

The content of the conductive auxiliary agent in the electrode composition is not particularly limited and is appropriately determined. For example, in 100% by mass of the solid content, it is preferably more than 0% by mass and 10% by mass or less, more preferably 1.0% to 5.0% by mass, and still more preferably 1.0% to 2.0% by mass.

<Polymer Binder (B)>

The electrode composition according to the embodiment of the present invention contains one kind or two or more kinds of the polymer binders (B). This polymer binder (B) is not particularly limited in terms of other characteristics as long as the conditions (1) to (4) are satisfied, and it is appropriately set.

The preferred characteristics or physical properties of the polymer binder (B) and the polymer (b) that constitutes the polymer binder (B) will be described.

(Preferred Physical Properties or Characteristics of Polymer Binder (B) and Polymer (b))

The polymer binder (B) preferably exhibits an adsorption rate [A_{SE}] of 45% or less with respect to the inorganic solid electrolyte (SE) in the dispersion medium (D) contained in the electrode composition.

In the electrode composition that contains the above components and satisfies each of the above conditions, in a case where the polymer binder (B) further satisfies the adsorption rate [A_{SE}], it properly adsorbs to the inorganic solid electrolyte (SE) in addition to the conductive auxiliary agent (CA), whereby the dispersibility of the inorganic solid electrolyte (SE) is enhanced, which makes it possible to further improve the dispersion characteristics of the electrode composition and makes it possible to construct sufficient conduction paths. From the viewpoints of the further improvement of the dispersion characteristics of the electrode composition, the construction of the conduction path, and the like, the adsorption rate [A_{SE}] is preferably 40% or less, more preferably 35% or less, and still more preferably 30% or less. On the other hand, the lower limit of the adsorption rate [A_{SE}] is practically 0% or more, and for example, it is preferably 5% or more and more preferably 10% or more.

In the present invention, the adsorption rate [A_{SE}] with respect to the inorganic solid electrolyte (SE) can be appropriately set depending on the kind (the structure and the composition of the polymer chain) of the polymer (b) that forms the polymer binder (B), the kind of the functional group selected from the group (a) of functional groups described later or the content of the functional group, the surface state of the inorganic solid electrolyte (SE), and the like.

The adsorption rate [A_{SE}] is an adsorption rate of the polymer binder (B) with respect to the inorganic solid electrolyte (SE) in the dispersion medium (D), where it is a value measured by using the inorganic solid electrolyte (SE), the polymer binder (B), and the dispersion medium (D), which are contained in the electrode composition, and it is an indicator that indicates the degree of adsorption of the polymer binder (B) with respect to the inorganic solid electrolyte (SE) in the dispersion medium (D). Here, the adsorption of the polymer binder (B) to the inorganic solid electrolyte (SE) includes not only physical adsorption but also chemical adsorption (adsorption by chemical bond formation, adsorption by transfer of electrons, or the like).

In a case where the electrode composition contains a plurality of kinds of inorganic solid electrolytes, the adsorption rate shall be defined as an adsorption rate with respect to the inorganic solid electrolyte having the same composition (kind and content) as the composition of the inorganic solid electrolyte in the electrode composition. Similarly, also in a case where the electrode composition contains a plurality of kinds of dispersion media, the adsorption rate shall be an adsorption rate in a case where a dispersion medium having the same composition as the dispersion media (in terms of kind and content) in the electrode composition is contained. In addition, also in a case where the electrode composition uses a plurality of kinds of polymer binders, the adsorption rate shall be an adsorption rate in the case where the plurality of kinds of polymer binders are used.

The adsorption rate [A_{SE}] (%) is measured as follows using the inorganic solid electrolyte (SE), the polymer binder (B), and the dispersion medium (D), which are used in the preparation of the electrode composition.

That is, the polymer binder (B) is dissolved in the dispersion medium (D) to prepare a binder solution having a concentration of 1% by mass. The binder solution and the inorganic solid electrolyte (SE) are placed in a vial of 15 ml at a proportion such that the mass ratio of the polymer binder (B) in this binder solution to the inorganic solid electrolyte (SE) is 42:1, and stirred for 1 hour with a mix rotor at room temperature (25° C.) and a rotation speed of 80 rpm, followed by being allowed to stand. The supernatant obtained by solid-liquid separation was filtered through a filter having a pore diameter of 1 μm, and the entire amount of the obtained filtrate has been dried to be solid, and then the mass W_{A} of the polymer binder (B) remaining in the filtrate (the mass of the polymer binder (B) that had not adsorbed to the inorganic solid electrolyte (SE)) is measured. From this mass W_{A} and the mass W_{B} of the polymer binder (B) contained in the binder solution used for the measurement, the adsorption rate of the polymer binder (B) with respect to the inorganic solid electrolyte (SE) is calculated according to the following expression. The average value of the adsorption rates obtained by carrying out this operation twice is defined as the adsorption rate [A_{SE}] (%).

Adsorption rate (%)=[(W_{B}−W_{A})/W_{B}]×100

In terms of improving the affinity with the polymer binder (B) and the dispersion medium (D) and the dispersion characteristics of the solid particles, the SP value of the polymer (b) is, for example, preferably 10 to 24 MPa^{1/2}, more preferably 14 to 22 MPa^{1/2}, and still more preferably 16 to 20 MPa^{1/2}.

A calculation method for an SP value will be described.

(1) The SP Value of the Constitutional Unit is Calculated.

First, in the polymer (b), a constitutional unit of which the SP value is specified is determined.

For example, in a case where the SP value of the polymer (b) is calculated, a constitutional unit that is the same as that of the constitutional component derived from the raw material compound is adopted in a case where the polymer is adopted as a chain polymerization polymer.

Next, the SP value for each constitutional unit is determined according to the Hoy method unless otherwise specified (see Table 5, Table 6, and the following expression in Table 6 in H. L. Hoy JOURNAL OF PAINT TECHNOLOGY, Vol. 42, No. 541, 1970, 76-118, and POLYMER HANDBOOK 4^{th}, Chapter 59, VII, page 686).

$${δ}_{t} = \frac{{F}_{t} + \frac{B}{\overline{n}}}{V} ; B = 277$$

In the expression, δₜ indicates an SP value. Fₜ is a molar attraction function (J×cm³)^{1/2}/mol and represented by the following expression. V is a molar volume (cm³/mol) and represented by the following expression. n̅ is represented by the following expression.

$${F}_{t} = \sum {n}_{i} {F}_{i , i}$$

$$V = {n}_{i} {V}_{i}$$

$$\overline{n} = \frac{0.5}{{Δ}_{T}^{( P )}}$$

$${Δ}_{T}^{( P )} = \sum {n}_{i} {Δ}_{T , i}^{( P )}$$

In the above expressions, F_{t,i} indicates a molar attraction function of each constitutional unit, Vᵢ indicates a molar volume of each constitutional unit, Δ^{(P)}_{T,i} indicates a correction value of each constitutional unit, and nᵢ indicates the number of each constitutional unit.

(2) SP Value of Polymer (b)

The SP value of the polymer (b) is calculated from the following expression using the constitutional unit determined as described above and the determined SP value. It is noted that the SP value of the constitutional unit determined according to the above document is converted into an SP value (unit: MPa^{1/2}) (for example, 1 cal^{1/2} cm^{-3/2}≈2.05 J^{1/2}cm^{3/2}≈2.05 MPa^{1/2}) and used.

SPₚ²=(SP₁²×W₁)+(SP₂²×W₂)+ . . .

In the expression, SP₁, SP₂ . . . indicates the SP values of the constitutional units, and W₁, W₂ . . . indicates the mass fractions of the constitutional units.

In the present invention, the mass fraction of a constitutional unit shall be a mass fraction of the constitutional component (the raw material compound from which this constitutional component is derived) in the polymer, corresponding to the constitutional unit.

The SP value of the polymer (b) can be adjusted depending on the kind or the composition (in terms of kind and content of the constitutional component) of the polymer (b).

It is preferable that the polymer (b) has an SP value that satisfies a difference (in terms of absolute value) in SP value in a range described later with respect to the SP value of the dispersion medium (D) from the viewpoint of achieving higher dispersion characteristics.

The watery moisture concentration of the polymer (b) is preferably 100 ppm (in terms of mass) or lower. In addition, as this polymer, a polymer may be crystallized and dried, or a polymer solution may be used as it is.

The polymer (b) is preferably noncrystalline. In the present invention, the description that a polymer is “noncrystalline” typically refers to that no endothermic peak due to crystal melting is observed when the measurement is carried out at the glass transition temperature.

The polymer (b) may be a non-crosslinked polymer or a crosslinked polymer. In addition, in a case where the crosslinking of the polymer (b) proceeds by heating or application of a voltage, it is preferable that the polymer (b) before crosslinking has a mass average molecular weight in a range defined in the above-described condition (3), and it is preferable that the polymer (b) at the start of use of the all-solid state secondary battery also has a mass average molecular weight in a range defined in the above-described condition (3).

It is preferable that the polymer (b) and the polymer binder (B) do not react with the inorganic solid electrolyte due to the heating step in the preparation of the electrode composition, the production of the electrode sheet for an all-solid state secondary battery, or the manufacturing of the all-solid state secondary battery, from the viewpoint that the deterioration of the dispersion characteristics, the application suitability, and the battery characteristics can be suppressed. Specifically, it is preferable that the polymer (b) does not have an ethylenic double bond. In the present invention, the fact that a polymer does not have an ethylenic double bond in the molecule includes an aspect in which a polymer has an ethylenic double bond within a range where the effect of the present invention is not impaired, for example, an abundance in the molecule (according to the nuclear magnetic resonance (NMR) spectroscopy method) is 0.1% or less.

(Polymer (b))

The polymer binder (b) is not particularly limited in terms of the kind and the composition thereof as well as the binding mode (the arrangement) or the like of the constitutional component that constitutes the main chain as long as the polymer (b) is a polymer that satisfies the condition (3) and can constitute the polymer binder (B) that satisfies the conditions (1), (2), and (4), and it is possible to use various polymers as polymers for a binder for an all-solid state secondary battery.

Preferred examples of the polymer (b) include a polymer having, in the main chain, at least one bond selected from a urethane bond, a urea bond, an amide bond, an imide bond, and an ester bond, or a polymerized chain of carbon-carbon double bonds. More specifically, examples of the polymer having, among the above bonds, a urethane bond, a urea bond, an amide bond, an imide bond, or an ester bond in the main chain include sequential polymerization (polycondensation, polyaddition, or addition condensation) polymers such as polyurethane, polyurea, polyamide, polyimide, and polyester. In addition, examples of the polymer having a polymerized chain of carbon-carbon double bonds in the main chain include chain polymerization polymers such as a fluoropolymer (a fluorine-containing polymer), a hydrocarbon polymer, a vinyl polymer, and a (meth)acrylic polymer. The binding mode of the main chain in these polymers is not particularly limited, and it may be any one of random bonding (for a random polymer), alternate bonding (for an alternating polymer), block bonding (for a block polymer), or graft bonding (for a graft polymer).

Among them, a chain polymerization polymer is preferable, a hydrocarbon polymer, a vinyl polymer, or a (meth)acrylic polymer is more preferable, and a (meth)acrylic polymer is still more preferable. In addition, the binding mode of the main chain is preferably random bonding or block bonding.

The polymer (b) that constitutes the polymer binder (B) may be one kind or two or more kinds. In a case where the polymer binder (B) is composed of two or more kinds of polymers (b), it is preferable that at least one kind of polymer is a chain polymerization polymer, and it is more preferable that all the polymers are chain polymerization polymers.

In the present invention, a main chain of the polymer refers to a linear molecular chain in which all the molecular chains that constitute the polymer other than the main chain can be conceived as a branched chain or a pendant group with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain.

The constitutional component that forms the polymer (b) is not particularly limited; however, examples thereof include a constitutional component having a functional group (a) selected from the group (a) of functional groups, a constitutional component having a substituent having 8 or more carbon atoms as a side chain, a macromonomer constituting component, and another constitutional component. It is noted that in a case of containing, as a polymerized chain constituting component, a constitutional component having the functional group (a) in the polymerized chain contained in the macromonomer constituting component, this macromonomer constituting component corresponds to the constitutional component having a functional group selected from the group (a) of functional groups.

Hereinafter, the constitutional component contained in the polymer (b) will be described.

(Constitutional Component Having Functional Group Selected from Group (a) of Functional Groups)

The polymer (b) preferably contains one kind or two or more kinds of constitutional components having a functional group (including a bond) selected from the following group (a) of functional groups. In a case where the polymer (b) has a constitutional component having this functional group (hereinafter, may be referred to as a functional group-containing constitutional component), the polymer binder (B) exhibits a suitable adsorptive force with respect to solid particles such as the conductive auxiliary agent (CA), which makes it possible to enhance the dispersion characteristics of the electrode composition.

This constitutional component may be any component that forms the polymer (b). The functional group may be incorporated into the main chain or the side chain of the polymer. In the case of being incorporated into the side chain, the functional group may be directly bonded to the main chain or may be bonded through a linking group. The linking group is not particularly limited; however, examples thereof include a linking group L^{F} described later.

<Group (a) of Functional Groups>

A hydroxy group, an amino group, a carboxy group, a sulfo group, a phosphate group, a phosphonate group, a sulfanyl group, an ether bond (—O—), an imino group (=NR, or —NR—), an ester bond (—CO—O—), an amide bond (—CO—NR—), a urethane bond (—NR—CO—O—), a urea bond (—NR—CO—NR—), a heterocyclic group, an aryl group, and a carboxylic acid anhydride group

Each of the amino group, the sulfo group, the phosphate group (the phosphoryl group), the phosphonate group, the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. In a case where a ring structure contains an amino group, an ether bond, an imino group (—NR—), an ester bond, an amide bond, a urethane bond, a urea bond, or the like, it is classified as a heterocycle. The hydroxy group, the amino group, the carboxy group, the sulfo group, the phosphate group, the phosphonate group, the sulfanyl group, or the like may form a salt. Examples of the salt include various metal salts and a salt of ammonium or amine.

In the chain polymerization polymer, the constitutional component having an ester bond (excluding an ester bond that forms a carboxy group) or an amide bond means a constitutional component in which an ester bond or an amide bond is not directly bonded to an atom that constitutes the main chain of a chain polymerization polymer and an atom that constitutes the main chain of a polymerized chain (for example, a polymerized chain contained in a macromonomer) that is incorporated into the chain polymerization polymer as a branched chain or a pendant chain, and it does not include, for example, a constitutional component derived from a (meth)acrylic acid alkyl ester.

The chemical formula described with parentheses after each bond name such as an ether bond indicates a chemical structure of the bond. A terminal group bonded to this group is not particularly limited. Examples thereof include groups selected from the substituent Z described later, which include, for example, an alkyl group. R in each bond represents a hydrogen atom or a substituent, and it is preferably a hydrogen atom. The substituent is not particularly limited. It is selected from a substituent Z described later, and an alkyl group is preferable. It is noted although an ether bond is included in a carboxy group, a hydroxy group, and the like, —O— included in these groups is not regarded as the ether bond.

The carboxylic acid anhydride group is not particularly limited; however, it includes a group obtained by removing one or more hydrogen atoms from a dicarboxylic acid anhydride (for example, a group represented by Formula (2a)), as well as a constitutional component itself (for example, a constitutional component represented by Formula (2b)) obtained by copolymerizing a polymerizable dicarboxylic acid anhydride as a copolymerizable compound. The group obtained by removing one or more hydrogen atoms from a dicarboxylic acid anhydride is preferably a group obtained by removing one or more hydrogen atoms from a cyclic dicarboxylic acid anhydride. Examples the dicarboxylic acid anhydride include acyclic dicarboxylic acid anhydrides such as acetic acid anhydride, propionic acid anhydride, and benzoic acid anhydride; and cyclic dicarboxylic acid anhydrides such as maleic acid anhydride, phthalic acid anhydride, fumaric acid anhydride, succinic acid anhydride, and itaconic acid anhydride. The polymerizable dicarboxylic acid anhydride is not particularly limited; however, examples thereof include a dicarboxylic acid anhydride having an unsaturated bond in the molecule, and a polymerizable cyclic dicarboxylic acid anhydride is preferable. Specific examples thereof include maleic acid anhydride and itaconic acid anhydride. The carboxylic acid anhydride group derived from a cyclic dicarboxylic acid anhydride also corresponds to a heterocyclic group; however, it is classified as a carboxylic acid anhydride group in the present invention.

Examples of the carboxylic acid anhydride group include a group represented by Formula (2a) and a constitutional component represented by Formula (2b); however, the present invention is not limited thereto. In each of the formulae, * represents a bonding position.

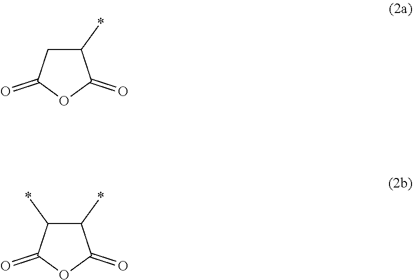 [SMILES: *C1CC(=O)OC1=O ; *C1C(=O)OC(=O)C1*]

The functional group contained in one functional group-containing constitutional component may be one kind or two or more kinds, and in a case where two or more kinds are contained, they may be or may not be bonded to each other.

In terms of the adsorptivity to the solid particles, particularly the conductive auxiliary agent (CA), and furthermore, in terms of the dispersion characteristics, the functional group is preferably a carboxy group, a hydroxy group, or a carboxylic acid anhydride group. In a case where the functional group-containing constitutional component has two or more kinds of functional groups, two or more kinds of functional groups included in the group (a) of functional groups can be appropriately combined. However, in terms of adsorptivity and dispersion characteristics, the preferred combination is a combination of an ether bond and an aryl group, a combination of a carboxy group and a hydroxy group, a combination of a carboxy group and a carboxylic acid anhydride group, or a combination of a carboxy group and a hydroxy group or carboxylic acid anhydride group.

The above-described functional group is preferably incorporated into the side chain of the polymer (b). In this case, examples of the functional group-containing constitutional component include a constitutional component having the above-described functional group, directly or through a linking group, in a partial structure that is incorporated into the main chain, or a constitutional component having a polymerized chain in which the above-described functional group is incorporated as a substituent, directly or through a linking group, in a partial structure that is incorporated into the main chain of the polymer (b).

Hereinafter, a description will be made for the constitutional component having the above-described functional group, directly or through a linking group, in a partial structure that is incorporated into the main chain, and the constitutional component having a polymerized chain will be described later.

In the constitutional component having a functional group, the partial structure to be incorporated into the main chain is not unambiguously determined depending on the kind of the polymer (B) and is appropriately selected. For example, in a case of a chain polymerization polymer, a carbon chain (a carbon-carbon bond) can be mentioned.

The linking group L^{F} that links the partial structure to be incorporated into the main chain to the above-described functional group is not particularly limited. However, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. The linking group is preferably a group composed of a combination of an alkylene group, an arylene group, a carbonyl group, an oxygen atom, a sulfur atom, and an imino group, still more preferably a group containing a —CO—O— group, a —CO—N(R^{N})— group (here, R^{N} is as described above), and particularly preferably a group obtained by combining a —CO—O— group or a —CO—N(R^{N})— group (R^{N} is as described above) and an alkylene group.

In the present invention, the number of atoms that constitute the linking group L^{F} is preferably 1 to 36, more preferably 1 to 24, still more preferably 1 to 12, and particularly preferably 1 to 6. The number of linking atoms of the linking group L^{F} is preferably 12 or less, more preferably 10 or less, and particularly preferably 8 or less. The lower limit thereof is 1 or more. The number of linking atoms refers to the minimum number of atoms linking predetermined structural parts. For example, in a case of —C(═O)—O—, the number of atoms that constitute the linking group L^{F} is 3; however, the number of linking atoms is 2.

Each of the partial structure to be incorporated into the main chain and the linking group L^{F} may have a substituent other than the above-described functional group. Such a substituent is not particularly limited, and examples thereof include a group selected from the substituent Z described later, where a group other than the functional group selected from the group (a) of functional groups is preferable.

The compound from which the above-described functional group-containing constitutional component is derived (also referred to as a compound having a functional group) is not particularly limited; however, examples thereof include a compound having at least one carbon-carbon unsaturated bond and at least one functional group described above. For example, it includes a compound in which a carbon-carbon unsaturated bond and the above-described functional group are directly bonded, a compound in which a carbon-carbon unsaturated bond and the above-described functional group are bonded through a linking group L^{F}, as well as a compound (for example, the polymerizable cyclic dicarboxylic acid anhydride) in which the above-described functional group itself contains a carbon-carbon unsaturated bond. Further, the compound having the above-described functional group include compounds that are capable of introducing a functional group into the polymer constitutional component after polymerization by various reactions (for example, alcohol and each of the amino, mercapto, and epoxy compounds (including polymers thereof), which are capable of undergoing an addition reaction or condensation reaction with a constitutional component derived from carboxylic acid anhydride, a constitutional component having a carbon-carbon unsaturated bond, or the like). Further, examples of the compound having the above-described functional group also include a compound in which a carbon-carbon unsaturated bond is bonded directly or through a linking group L^{F} to a macromonomer having a functional group incorporated as a substituent in the polymerized chain.

The above-described functional group-containing constitutional component is not particularly limited as long as it has the above-described functional group; however, examples thereof include a constitutional component obtained by introducing the above-described functional group into a (meth)acrylic compound (M1) or another polymerizable compound (M2) described later, a constitutional component represented by any one of Formulae (b-1) to (b-3), or a constitutional component represented by Formulae (1-1) described later. Specific examples of the above-described functional group-containing constitutional component include constitutional components in the exemplary polymers described later and the polymers synthesized in Examples; however, the present invention is not limited thereto.

The compound from which a constitutional component having the above-described functional group is derived is not particularly limited; however, examples thereof include a polymerizable cyclic dicarboxylic acid anhydride and a compound in which the above-described functional group is introduced into a (meth)acrylic acid short-chain alkyl ester compound (here, short-chain alkyl means an alkyl group having 3 or less of carbon atoms). It is noted that examples of the compound obtained by introducing the above-described functional group into a polymerizable cyclic dicarboxylic acid anhydride include a dicarboxylic acid monoester compound that is obtained by subjecting a maleic acid anhydride compound and an alcohol to an addition reaction (a ring-opening reaction).

In terms of the dispersion characteristics and the adsorptivity of the polymer binder (B), the total content of the above-described functional group-containing constitutional component in the polymer (b) is preferably 0.01% to 40% by mass, more preferably 0.02% to 30% by mass, still more preferably 0.05% to 20% by mass, and particularly preferably 0.1% to 10% by mass, where it is also particularly preferably 0.2% to 8% by mass.

In a case where the polymer (b) has a plurality of functional group-containing constitutional components, the total content of the functional group-containing constitutional components shall be the total content of the respective constitutional components. In addition, the content of the functional group-containing constitutional component generally means, even in a case where one constitutional component has a plurality of functional groups or a plurality of kinds of functional groups, the content of this constitutional component. Further, a content of a constitutional component (a macromonomer constituting component) which will be described later, which has a polymerized chain into which the above-described functional group is incorporated as a substituent is also included for calculation in the total content of the functional group-containing constitutional component.

In a case where the polymer (b) has a plurality of functional group-containing constitutional components (including a macromonomer constituting component), the content of the following functional group-containing constitutional component is appropriately determined in consideration of the above-described total content. For example, in a case where the polymer (b) has two kinds of functional group-containing constitutional components, the content of one of the functional group-containing constitutional components is, for example, preferably 0.005% to 30% by mass, more preferably 0.01% to 20% by mass, still more preferably 0.05% to 8% by mass, and particularly preferably 0.1% to 3% by mass. The content of the other functional group-containing constitutional component is, for example, preferably 0.005% to 10% by mass, more preferably 0.01% to 10% by mass, and still more preferably 0.05% to 2% by mass. In addition, the mass ratio of the content of one functional group-containing constitutional component to the content of the other functional group-containing constitutional component [the content of one functional group-containing constitutional component/the content of the other functional group-containing constitutional component] is, for example, preferably 0.001 to 5,000, more preferably 0.01 to 1,000, and still more preferably 0.02 to 200.

In a case where the polymer (b) contains a functional group-containing constitutional component having a carboxy group and a functional group-containing constitutional component having a carboxylic acid anhydride group, the content of each of the functional group-containing constitutional component having a carboxy group and the functional group-containing constitutional component having an carboxylic acid anhydride group, in the polymer, is appropriately determined in consideration of the above-described total content. For example, in one preferred aspect, it can be set in the same range as the range of each content in a case where the polymer (b) has two kinds of functional group-containing constitutional components. However, the content of the functional group-containing constitutional component having a carboxy group may be the content of one functional group-containing constitutional component or the content of the other functional group-containing constitutional component.

(Constitutional Component Having Substituent Having 8 or More Carbon Atoms as Side Chain)

The polymer (b) preferably contains, as a side chain, one kind or two or more kinds of constitutional component having a substituent having 8 or more carbon atoms. In a case where the polymer (b) has this constitutional component, the polarity (SP value) of the polymer (b) is decreased, whereby it is possible to increase the solubility of the polymer binder (B) in the dispersion medium (D), which leads to the improvement of dispersion characteristics.

This constitutional component may be any constitutional component that forms the polymer (b), and a substituent thereof having 8 or more carbon atoms is introduced as a side chain of the polymer (b) or a part thereof. This constitutional component has a substituent having 8 or more carbon atoms, directly or through a linking group in a partial structure that is incorporated into the main chain of the polymer (b).

The partial structure that is incorporated into the main chain of the polymer is appropriately selected depending on the kind of the polymer and the like, and it is as described above.

The substituent having 8 or more carbon atoms is not particularly limited, and examples thereof include a group having 8 or more carbon atoms among the substituent Z, which will be described later. In a case where the constitutional component includes a polymerized chain as a side chain, the substituent having 8 or more carbon atoms includes a substituent having 8 or more carbon atoms contained in each constitutional component that constitutes this polymerized chain; however, it shall not be allowed to regard the entire polymerized chain as a substituent and regard it as a substituent having 8 or more carbon atoms.

Specific examples of the substituent having 8 or more carbon atoms include a long-chain alkyl group having 8 or more carbon atoms, a cycloalkyl group having 8 or more carbon atoms, an aryl group having 8 or more carbon atoms, an aralkyl group having 8 or more carbon atoms, and a heterocyclic group having 8 or more carbon atoms, where a long-chain alkyl group having 8 or more carbon atoms is preferable.

The number of carbon atoms of this substituent may be any number as long as it is 8 or more, and it is preferably 10 or more and more preferably 12 or more. The upper limit thereof is not particularly limited, and it is preferably 24 or less, more preferably 20 or less, and still more preferably 16 or less. The number of carbon atoms of the substituent indicates the number of carbon atoms that constitute this substituent, and in a case where this substituent further has a substituent, the number of carbon atoms that constitute the substituent that is further contained is included for calculation.

The linking group that links a partial structure to be incorporated into the main chain to a substituent having 8 or more carbon atoms is not particularly limited, and it is the same as the linking group L^{F} in the functional group-containing constitutional component described above, where it is particularly preferably a —CO—O— group or —CO—N(RN)— group (R^{N} is as described above).

Each of the partial structure, the linking group, and the substituent having 8 or more carbon atoms, which are incorporated into the main chain, may have a substituent. Such a substituent is not particularly limited, and examples thereof include a group selected from the substituent Z described later, where a group other than the functional group selected from the group (a) of functional groups is preferable.

The constitutional component having a substituent having 8 or more carbon atoms can be constituted by appropriately combining the above-described partial structure incorporated into the main chain, a substituent having 8 or more carbon atoms, and a linking group, and it is, for example, preferably a constitutional component represented by Formula (1-1).

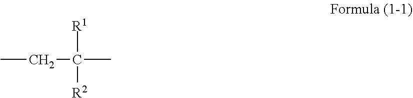

In Formula (1-1), R¹ represents a hydrogen atom or an alkyl group (preferably having 1 to 12 carbon atoms, more preferably 1 to 6 carbon atoms, and still more preferably 1 to 3 carbon atoms). The alkyl group that can be adopted as R¹ may have a substituent. The substituent is not particularly limited; however, examples thereof include the substituent Z described above. A group other than the functional group selected from the group (a) of functional groups is preferable, and suitable examples thereof include a halogen atom.

R² represents a group having a substituent having 8 or more carbon atoms. In the present invention, the group having a substituent includes a group consisting of the substituent itself (where the substituent is directly bonded to the carbon atom in the above formula, to which R¹ is bonded), a linking group that links a carbon atom in the above formula to which R² is bonded, to a substituent, and a group consisting of a substituent (where the substituent is bonded through a linking group, to the carbon atom in the above formula, to which R¹ is bonded).

The substituent having 8 or more carbon atoms contained in R² and the linking group which may be contained in R² are as described above. R² is particularly preferably a long-chain alkyl group having 8 or more carbon atoms on the right side of —C(═O)—O—.

In Formula (1-1), the carbon atom adjacent to the carbon atom to which R¹ is bonded has two hydrogen atoms; however, in the present invention, it may have one or two substituents. The substituent is not particularly limited; however, examples thereof include a substituent Z described later, and a group other than the functional group selected from the Group (a) of functional groups is preferable.

It is preferable that the constitutional component having a substituent having 8 or more carbon atoms is, for example, a constitutional component derived from a compound having a substituent having 8 or more carbon atoms among the (meth)acrylic compounds (M1) described later, or a constitutional component derived from a compound having a substituent having 8 or more carbon atoms among other polymerizable compounds (M2) described later, where a long-chain alkyl ester compound of a (meth)acrylic acid (having 8 or more carbon atoms) is preferable.

Specific examples of the constitutional component having a substituent having 8 or more carbon atoms include constitutional components in the exemplary polymers described later and the polymers synthesized in Examples; however, the present invention is not limited thereto.

The content of the constitutional component having a substituent having 8 or more carbon atoms in the polymer (b) is not particularly limited, and in terms of the dispersion characteristics of the binder (B), it is preferably 20% to 99.9% by mass, more preferably 30% to 99.5% by mass, still more preferably 40% to 99% by mass, particularly preferably 60% to 98% by mass, and most preferably 80% to 95% by mass.

(Another Constitutional Component)

The polymer (b) may contain a constitutional component (referred to as another constitutional component) other than the above-described functional group-containing constitutional component and other than the constitutional component having a substituent having 8 or more carbon atoms. The other constitutional component is not particularly limited as long as it can constitute the polymer (b) and can be appropriately selected depending on the kind of the polymer (b). Examples thereof include a constitutional component derived from a compound that does not have the above-described functional group and the above-described substituent having 8 or more carbon atoms, among the (meth)acrylic compound (M1) and the other polymerizable compound (M2) described later.

Preferred examples of the other constitutional component include a constitutional component having a substituent having 7 or less carbon atoms. This constitutional component is the same as the above-described constitutional component having a substituent having 8 or more carbon atoms, except that it has a substituent having 7 or less carbon atoms instead of the substituent having 8 or more carbon atoms. Specifically, it is preferably a constitutional component derived from an alkyl ester compound of (meth)acrylic acid, having 7 or less carbon atoms, examples of which include a constitutional component derived from methyl (meth)acrylate, ethyl (meth)acrylate, or the like.

The content of the other constitutional component in the polymer (b) is not particularly limited and is appropriately determined from a range of 0% to 100% by mass in consideration of the contents of the above-described constitutional components. In a case where the polymer (b) contains another constitutional component, the content of the other constitutional component is, for example, preferably 1% to 60% by mass, more preferably 2% to 40% by mass, and still more preferably 5% to 20% by mass.

(Macromonomer Constituting Component)

The polymer (b) preferably has a main chain composed of at least one of the above-described constitutional components, and an aspect in which a macromonomer constituting component is further contained in the main chain of the polymer (b) (the polymer (b) corresponds to a graft polymer) is also one of the preferred aspects of the present invention. That is, each of the above-described constitutional components may be incorporated as a main chain constituting component that constitutes the main chain of the polymer (b), or it may be incorporated as a side chain of the polymer (b), for example, as a polymerized chain constituting component that constitutes a polymerized chain.

In a case where each constitutional component is incorporated as a polymerized chain constituting component that constitutes a side chain of the polymer (b), for example, a polymerized chain, the main chain constituting component that constitutes the main chain of the polymer (b) can be a constitutional component (also referred to as a macromonomer constituting component) derived from a macromonomer having a polymerized chain. Examples of the macromonomer from which the macromonomer constituting component is derived include those having a polymerized chain directly or through a linking group, in a partial structure that is incorporated into the main chain of the polymer (b). The partial structure that is incorporated into the main chain of the polymer is appropriately selected depending on the kind of the polymer and the like, and it is as described above. The linking group is not particularly limited and it is the same as the linking group L^{F} in the functional group-containing constitutional component described above. However, it preferably includes a linking group including a structural part (a residue) derived from a chain transfer agent to be used in the synthesis of the above-described polymerized chain, a polymerization initiator, or the like; and a linking group obtained by linking this structural part (residue) and a structural part derived from the (meth)acrylic compound (M1) that reacts with the chain transfer agent, for example, a structural part (a glycidyl group) derived from a glycidyl (meth)acrylic acid ester compound. The chain transfer agent is not particularly limited; however, examples thereof include 3-mercaptopropionic acid, mercaptoacetic acid, 2-mercaptopropionic acid, 3-mercaptoisobutyric acid, 2-mercaptoethanol, 6-mercapto-1-hexanol, 2-amino, ethanethiol, and 2-aminoethanethiol hydrochloride. Examples of the linking group consisting of a structural part derived from a chain transfer agent and a structural part derived from the (meth)acrylic compound (M1) include a —CO—O-alkylene group-X—CO—(X)n-alkylene-S— group. Here, X represents an oxygen atom or —NH—, and n is 0 or 1. More specific examples of the linking group include a linking group of the constitutional component (X) contained in each of the polymers synthesized in Examples. The number of atoms constituting the linking group in the macromonomer is preferably 1 to 36, more preferably 1 to 30, and still more preferably 1 to 24. The number of linking atoms of the linking group is preferably 16 or less, more preferably 12 or less, and particularly preferably 10 or less.

The polymerized chain contained in the macromonomer is not particularly limited. Examples thereof include a polymerized chain that has, as a polymerized chain constituting component, a functional group-containing constitutional component, a constitutional component having a substituent having 8 or more carbon atoms, another constitutional component, and the like, specific examples thereof include a polymerized chain of a chain polymerization polymer described later. In a case where the polymerized chain contains the above-described functional group-containing constitutional component as the polymerized chain constituting component thereof, this macromonomer constituting component corresponds to the above-described functional group-containing constitutional component (the above-described “constitutional component having a polymerized chain”) that constitutes the polymer (b), regardless of the presence or absence of the constitutional component having a substituent having 8 or more carbon atoms and the other components. However, even in a case where the macromonomer constituting component has a linking group having a functional group selected from the group (a) of functional groups, it shall be regarded as the “macromonomer constituting component” as long as the polymerized chain does not contain the above-described functional group-containing constitutional component.

Each of the contents of the functional group-containing constitutional components, the constitutional component having a substituent having 8 or more carbon atoms, and the other constitutional component in the polymerized chain is not particularly limited; however, in a case of being converted into the content in the polymer (b), it is preferably in such a range that the above-described content of each constitutional component in the polymer (b) is satisfied. As an example of the content of each constitutional component, for example, the content of the functional group-containing constitutional component that is incorporated into the macromonomer is preferably 1% to 100% by mass, more preferably 3% to 80% by mass, still more preferably 5% to 70% by mass, and particularly preferably 5% to 25% by mass. The content of the constitutional component having a substituent having 8 or more carbon atoms is preferably 0% to 90% by mass. In one aspect, it is more preferably 1% to 70% by mass and still more preferably 5% to 50% by mass, and in another aspect, it is more preferably 70% to 90% by mass. The content of the other constitutional component is preferably 0% to 50% by mass, more preferably 0% to 30% by mass, and still more preferably 0%% to 20% by mass.

The number average molecular weight of the macromonomer is not particularly limited; however, it is preferably 500 to 100,000, more preferably 1,000 to 50,000, and still more preferably 2,000 to 20,000, in that the binding force of solid particles as well as the adhesiveness to the collector can be further strengthened while maintaining excellent dispersion characteristics.

The content of the macromonomer constituting component in the polymer (b) is included for calculation in the content of each of the above-described constitutional components to which macromonomer constituting components correspond and then is set in a range in which each content is satisfied. The content of the macromonomer constituting component alone in the polymer (b) is, for example, preferably 0.1% to 70% by mass, more preferably 2% to 70% by mass, still more preferably 5% to 60% by mass, particularly preferably 8% to 50% by mass, and most preferably 10% to 40% by mass, in terms of the dispersion characteristics, the adsorptivity, and the like of the polymer binder (B).

Hereinafter, a chain polymerization polymer suitable for the present invention will be specifically described.

(Hydrocarbon Polymer)

Examples of the hydrocarbon polymer include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

The hydrocarbon polymer preferably contains the above-described functional group-containing constitutional component, and it preferably contains, for example, a constitutional component derived from a polymerizable cyclic dicarboxylic acid anhydride such as maleic acid anhydride. It preferably further contains the above-described constitutional component having a substituent having 8 or more carbon atoms.

The content of the constitutional component in the hydrocarbon polymer is not particularly limited, and it is appropriately selected in consideration of the conditions (1) to (4), the physical properties, and the like. For example, it can be set in the above-described range.

(Vinyl Polymer)

Examples of the vinyl polymer include a polymer containing a vinyl-based monomer other than the (meth)acrylic compound (M1), where the content of the vinyl polymer is, for example, 50% by mole or more. Examples of the vinyl-based monomer include vinyl compounds described later. Specific examples of the vinyl polymer include polyvinyl alcohol, polyvinyl acetal, polyvinyl acetate, and a copolymer containing these.

This vinyl polymer preferably contains, in addition to the constitutional component derived from a vinyl-based monomer, the above-described functional group-containing constitutional component, and it preferably further contains the above-described constitutional component having a substituent having 8 or more carbon atoms.

The content of the constitutional component in the vinyl polymer is not particularly limited, and it is appropriately selected in consideration of the conditions (1) to (4), the physical properties, and the like. For example, the content of the constitutional component derived from a vinyl-based monomer in all the constitutional components that constitute the vinyl polymer is preferably the same as the content of the constitutional component derived from the (meth)acrylic compound (M1) in the (meth)acrylic polymer. Here, in a case where the constitutional component having a substituent having 8 or more carbon atoms, the constitutional component having a functional group, and the like are a constitutional component derived from a vinyl-based monomer, the contents of the constitutional components are included for calculation in the content of the constitutional component derived from a vinyl-based monomer. Each of the content of the above-described constitutional component having a substituent having 8 or more carbon atoms and the content of the above-described constitutional component having a functional group in all the constitutional components that constitute the vinyl polymer are as described above. The content of the constitutional component derived from the (meth)acrylic compound (M1) in the polymer is not particularly limited as long as it is less than 50% by mole; however, it is preferably 0% to 30% by mole.

((Meth)Acrylic Polymer)

The (meth)acrylic polymer is preferably a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound, and is preferably a polymer having a constitutional component derived from this (meth)acrylic compound (M1) and at least one of a constitutional component having a substituent having 8 or more carbon atoms or a constitutional component having a functional group. In addition, a polymer containing a constitutional component derived from the other polymerizable compound (M2) is also preferable.

Examples of the (meth)acrylic acid ester compound include a (meth)acrylic acid alkyl ester compound, a (meth)acrylic acid aryl ester compound, a (meth)acrylic acid ester compound having a heterocyclic group, and a (meth)acrylic acid ester compound having a polymerized chain, where a (meth)acrylic acid alkyl ester compound is preferable. The number of carbon atoms of the alkyl group that constitutes the (meth)acrylic acid alkyl ester compound is not particularly limited; however, it can be set to, for example, 1 to 24, and it is preferably 3 to 20, more preferably 4 to 16, and still more preferably 8 to 14, in terms of dispersibility and adhesiveness. The number of carbon atoms of the aryl group that constitutes the aryl ester is not particularly limited; however, it can be set to, for example, 6 to 24, and it is preferably 6 to 10 and more preferably 6. In the (meth)acrylamide compound, the nitrogen atom of the amide group may be substituted with an alkyl group or an aryl group.

The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include the “vinyl-based monomer” disclosed in JP2015-88486A.

The (meth)acrylic compound (M1) and the other polymerizable compound (M2) may have a substituent. The substituent is not particularly limited, and examples thereof preferably include a group selected from the substituent Z described later.

The content of the constitutional component in the (meth)acrylic polymer is not particularly limited, and it is appropriately selected in consideration of the conditions (1) to (4), the physical properties, and the like. For example, the content of the constitutional component derived from the (meth)acrylic compound (M1) in all the constitutional components that constitute the (meth)acrylic polymer is not particularly limited and is appropriately set in a range of 0% to 100% by mole. The upper limit thereof can be also set to, for example, 90% by mole. Here, in a case where the constitutional component having a substituent having 8 or more carbon atoms, the functional group-containing constitutional component, and the like are a constitutional component derived from the (meth)acrylic compound (M1), the contents of the constitutional components are included for calculation in the content of the constitutional component derived from the (meth)acrylic compound (M1). Each of the content of the above-described constitutional component having a substituent having 8 or more carbon atoms and the contents of the above-described constitutional component of the above-described functional group and the other constitutional component in all the constitutional components that constitute the (meth)acrylic polymer is as described above. The content of the other polymerizable compound (M2) in all the constitutional components that constitute the (meth)acrylic polymer is not particularly limited; however, it can be set to, for example, 50% by mole or less, and it is preferably 1% to 30% by mole, more preferably 1% to 20% by mole, and still more preferably 2.5% to 20% by mole.

The (meth)acrylic compound (M1) and the other polymerizable compound (M2), from which the constitutional components of the (meth)acrylic polymer and the vinyl polymer are derived, are preferably a compound represented by Formula (b-1). It is preferable that this compound is different from a compound from which a constitutional component having a substituent having 8 or more carbon atoms is derived or a compound from which the above-described functional group-containing constitutional component is derived.

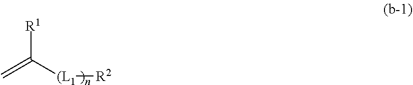

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The number of carbon atoms of the alkyl group has the same meaning as the number of carbon atoms of the alkyl group that constitutes the (meth)acrylic acid alkyl ester compound, where a long-chain alkyl ester having 8 or more carbon atoms or an alkyl ester having 7 or less carbon atoms is preferable.

L¹ is a linking group and is not particularly limited; however, examples thereof include a linking group in the above-described constitutional component having a substituent having 8 or more carbon atoms. The above-described linking group may have any substituent. The number of atoms that constitute the linking group and the number of linking atoms are as described above. Examples of any substituent include a substituent Z described later, and examples thereof include an alkyl group and a halogen atom.

n is 0 or 1 and preferably 1. However, in a case where -(L¹)ₙ-R² represents one kind of substituent (for example, an alkyl group), n is set to 0, and R² is set to a substituent (an alkyl group).

In Formula (b-1), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

In addition, the group which may adopt a substituent such as an alkyl group, an aryl group, an alkylene group, or an arylene group may have a substituent within a range where the effect of the present invention is not impaired. The substituent is not particularly limited, and examples thereof include a group selected from the substituent Z described later, where specific examples thereof include a halogen atom.

Examples of the preferred (meth)acrylic compound (M1) include a compound represented by Formula (b-2) or (b-3). It is preferable that this compound is different from a compound from which a constitutional component having a substituent having 8 or more carbon atoms is derived or a compound from which the above-described constitutional component having a functional group is derived.

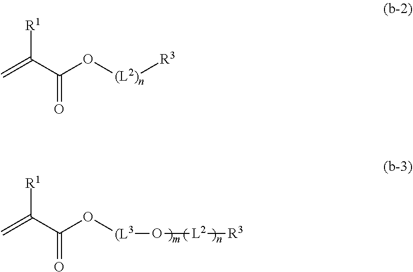

R¹ and n respectively have the same meanings as those in Formula (b-1).

R³ has the same meaning as R².

L² is a linking group, and the description for L¹ described above can be preferably applied thereto.

L³ is a linking group, and the description for L¹ described above can be preferably applied thereto, and it is preferably an alkylene group having 1 to 6 carbon atoms (preferably 1 to 3 carbon atoms).

m is an integer of 1 to 200, and it is preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formulae (b-1) to (b-3), the group which may take a substituent such as an alkyl group, an aryl group, an alkylene group, or an arylene group may have a substituent within a range where the effect of the present invention is not impaired. It suffices that the substituent is a substituent other than the functional group selected from the Group (a) of functional groups. Examples thereof include a group selected from the substituent Z described later, and specific examples thereof include a halogen atom.

As described above, the polymer (b) is preferably a random polymer or a block polymer. In a case where the polymer (b) is a block polymer, the number of blocks (segments) that forms a block polymer is not particularly limited as long as it is 2 or more, and it can be set to 2 to 5, where it is preferably 2 or 3.

In a case of assuming that blocks that form a block polymer are denoted by A, B, and C, which are different from each other, examples of the block polymer include an AB type (a polymer in which one block A and one block B are bonded to form one polymer chain (main chain)), an ABA type (a polymer in which two blocks A are bonded to both ends of one block B to form one polymer chain (main chain)), and an ABC type (a polymer in which one block A, one block B, and one block C are bonded in this order to form one polymer chain (main chain)). Among these, an ABA type is preferable.

Here, each of the blocks A, B, and C may be a block consisting of one kind of constitutional component or may be a block having two or more kinds of constitutional components. In a case where two or more kinds of the constitutional components are contained, the bonding mode (arrangement) of each of the constitutional components is not particularly limited and may be any one of random bonding, alternating bonding, block bonding, or the like, where random bonding is preferable.

In the polymer (b), the constitutional component that constitutes the block A is not particularly limited; however, it is preferable to contain the above-described other constitutional component, and it is more preferable to contain a constitutional component derived from an alkyl ester compound of (meth)acrylic acid, having 7 or less carbon atoms. The constitutional component that constitutes the block B is not particularly limited; however, it preferably contains the above-described functional group-containing constitutional component and the above-described constitutional component having a substituent having 8 or more carbon atoms. The polymer (b) having such a block can improve the dispersion characteristics.

The content of each block in the block polymer is not particularly limited, and it is appropriately set in consideration of the conditions (1) to (4), the physical properties, and the like. For example, In the polymer (b), the content of the block A containing the above-described constitutional component is preferably 5% to 60% by mass, more preferably 8% to 50% by mass, and still more preferably 10% to 40% by mass. In the polymer (b), the content of the block B containing the functional group-containing constitutional component and the constitutional component having a substituent having 8 or more carbon atoms is preferably 40% to 95% by mass, more preferably 50% to 92% by mass, and still more preferably 60% to 90% by mass.

The content of each constitutional component in the block polymer is not particularly limited, and it is set to the above-described content in all the constitutional components of the polymer (b) depending on the kind of the polymer (b).

An appropriate group such as a hydrogen atom, a chain transfer agent residue, an initiator residue, or the like is introduced into the terminal group of the polymer (b) by a polymerization method, a polymerization termination method, or the like.

The chain polymerization polymer (each constitutional component and raw material compound) may have a substituent. The substituent is not particularly limited, and preferred examples thereof include a group selected from the substituent Z. However, a group other than the functional group included in the above-described group (a) of functional groups is preferable.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which a —O—CO— group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonlyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, or a nicotinoyloxy group); an aryloyloxy group (preferably an aryloyloxy group having 7 to 23 carbon atoms, for example, a benzoyloxy group or a naphthoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R′)₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

The chain polymerization polymer can be synthesized by selecting a raw material compound and polymerizing the raw material compound according to a known method. In addition, a method of synthesizing the block polymer is not particularly limited either, and a known method can be employed. Examples thereof include a living radical polymerization method. Examples of the living radical polymerization method include an atomic transfer radical polymerization method (an ATRP method), a reversible addition-fragmentation chain transfer polymerization method (a RAFT method), and a nitroxide-mediated polymerization method (an NMP method)

The method of incorporating a functional group is not particularly limited, and examples thereof include a method of copolymerizing a compound having a functional group selected from the group (a) of functional groups, a method of using a polymerization initiator having (generating) the above-described functional group or a chain transfer agent, a method of using a polymeric reaction, an ene reaction or ene-thiol reaction with a double bond, and an atom transfer radical polymerization (ATRP) method using a copper catalyst. In addition, a functional group can be introduced by using a functional group that is present in the main chain, the side chain, or the terminal of the polymer, as a reaction point. For example, a functional group selected from the group (a) of functional groups can be introduced by various reactions with a carboxylic acid anhydride group in a polymerized chain using a compound having a functional group.

Specific examples of the polymer that constitutes a polymer binder include polymers C-1 to C-14 shown below and each of the polymers synthesized in Examples, the present invention is not limited thereto. It is noted that in the chemical formulae of the following polymers, in a case where blocks are denoted by A and B, “A-block-B” is a notation based on the basic raw material nomenclature of the copolymer, and “-block-” indicates a block polymer consisting of a block of a constitutional component A and a block of a constitutional component B. In the following chemical formulae, the numerical value at the bottom right of each constitutional component means a content (% by mass), and Me indicates a methyl group.

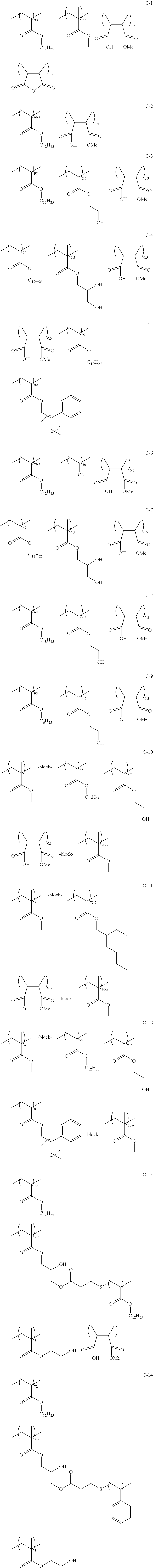

The polymer binder (B) contained in the electrode composition according to the embodiment of the present invention may be one kind or two or more kinds.

In terms of the dispersion characteristics, the adhesiveness of the solid particles, and the cycle characteristics, the content of the polymer binder (B) in the electrode composition is preferably 0.1% to 10% by mass, more preferably 0.3% to 8% by mass, still more preferably 0.5% to 7% by mass, and particularly preferably 0.5% to 3% by mass in 100% by mass of the solid content.

In the present invention, the mass ratio [(the mass of the inorganic solid electrolyte+the mass of the active material)/(the total mass of the polymer binder)] of the total mass (the total content) of the inorganic solid electrolyte and the active material to the total content of the polymer binder in 100% by mass of the solid content is preferably in a range of 1,000 to 1. Furthermore, this ratio is more preferably 500 to 2 and still more preferably 100 to 10.

(Another Polymer Binder)

The electrode composition according to the present invention may contain one kind or two or more kinds of polymer binders other than the polymer binder (B), for example, a polymer binder (also referred to as another polymer binder) that does not satisfy any of the conditions (1) to (4). Examples of the other polymer binder include a polymer binder (a particulate binder) that is present (dispersed) in a particle shape in the electrode composition without being dissolved in the dispersion medium, and a polymer binder (a high adsorption binder) in which the adsorption rate [A_{CA}] with respect to the conductive auxiliary agent is more than 50%. The particle diameter of this particulate binder is preferably 1 to 1,000 nm. The particle diameter can be measured in the same manner as in the measurement of the particle diameter of the inorganic solid electrolyte. As the other polymer binder, various polymer binders that are used in the manufacturing of an all-solid state secondary battery can be used without particular limitation.

The content of the other polymer binder in the electrode composition is not particularly limited; however, it is, for example, preferably 0.01% to 4% by mass in 100% by mass of the solid content.

<Dispersion Medium (D)>

The electrode composition according to the embodiment of the present invention contains the dispersion medium (D) that disperses or dissolves each of the above components.

Such a dispersion medium may be any organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally means a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The dispersion medium preferably has low polarity (is preferably a low-polarity dispersion medium) in terms of dispersion characteristics and in terms of preventing the deterioration (decomposition) of a sulfide-based inorganic solid electrolyte in a case where the sulfide-based inorganic solid electrolyte is used as the inorganic solid electrolyte. For example, the SP value (unit: MPa^{1/2}) can be generally set in a range of 15 to 27; however, it is preferably 17 to 22, more preferably 17.5 to 21, and still more preferably 18 to 20.

The difference (in terms of absolute value, unit: MPa^{1/2}) between the SP value of the polymer binder (B) and the SP value of the dispersion medium (D) is not particularly limited. However, it is preferably 3.0 or less, more preferably 0 to 2.5, and still more preferably 0 to 2.0 in terms of further improving the dispersion characteristics, and it is particularly preferably 0 to 1.7 in terms of further improving application suitability. In a case where the electrode composition contains a plurality of kinds of the polymer binders (B), it is preferable that the difference (in terms of absolute value) in SP value is such that the smallest value (in terms of absolute value) of the difference is within the above-described range.

The SP value of the dispersion medium is defined as a value obtained by converting the SP value calculated according to the Hoy method described above into the unit of MPa^{1/2}. In a case where the electrode composition contains two or more kinds of dispersion media, the SP value of the dispersion medium (D) means the SP value of the entire dispersion media, and it is the total sum of the products of the SP values and the mass fractions of the respective dispersion media. Specifically, the calculation is carried out in the same manner as the above-described calculation method for the SP value of the polymer, except that the SP value of each of the dispersion media is used instead of the SP value of the constitutional component.

The SP values (unit is omitted) of the dispersion media are shown below. It is noted that in the following compound names, the alkyl group means a normal alkyl group unless otherwise specified.

MIBK (18.4), diisopropyl ether (16.8), dibutyl ether (17.9), diisopropyl ketone (17.9), DIBK (17.9), butyl butyrate (18.6), butyl acetate (18.9), toluene (18.5), xylene (a mixture of xylene isomers in which the mixing molar ratio between isomers is, ortho-isomer:para-isomer:meta-isomer=1:5:2) (18.7), octane (16.9), ethylcyclohexane (17.1), cyclooctane (18.8), isobutyl ethyl ether (15.3), N-methylpyrrolidone (NMP, SP value: 25.4), perfluorotoluene (SP value: 13.4)

The boiling point of the dispersion medium at normal pressure (1 atm) is not particularly limited; however, it is preferably 90° C. or higher, and it is more preferably 120° C. or higher. The upper limit thereof is preferably 230° C. or lower and more preferably 200° C. or lower.

The dispersion medium contained in the electrode composition according to the embodiment of the present invention may be one kind or may be two or more kinds. Examples of the example thereof in which two or more kinds of dispersion media are contained include mixed xylene (a mixture of o-xylene, p-xylene, m-xylene, and ethylbenzene).

The content of the dispersion medium in the electrode composition is not particularly limited and is set in a range in which the above-described concentration of solid contents is satisfied.

<Lithium Salt>

The electrode composition according to the embodiment of the present invention can also contain a lithium salt (supporting electrolyte). Generally, the lithium salt is preferably a lithium salt that is used for this kind of product and is not particularly limited. For example, lithium salts described in paragraphs 0082 to 0085 of JP2015-088486A are preferable. In a case where the electrode composition according to the embodiment of the present invention contains a lithium salt, the content of the lithium salt is preferably 0.1 parts by mass or more and more preferably 5 parts by mass or more with respect to 100 parts by mass of the inorganic solid electrolyte. The upper limit thereof is preferably 50 parts by mass or less and more preferably 20 parts by mass or less.

<Dispersing Agent>

Since the above-described polymer binder (B) also functions as a dispersing agent, the electrode composition according to the embodiment of the present invention may not contain a dispersing agent other than the polymer binder (B). In a case where the electrode composition contains a dispersing agent other than the polymer binder (B), a dispersing agent that is generally used for an all-solid state secondary battery can be appropriately selected and used as the dispersing agent. Generally, a compound intended for particle adsorption and steric repulsion and/or electrostatic repulsion is suitably used.

<Other Additives>

As a component other than each of the above components described above, the electrode composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an anti-foaming agent, a leveling agent, a dehydrating agent, or an antioxidant. The ionic liquid is contained in order to further improve the ion conductivity, and the known one in the related art can be used without particular limitation. In addition, a usually used binding agent or the like may be contained.

(Preparation of Electrode Composition)

The electrode composition according to the embodiment of the present invention can be prepared according to a conventional method. Specifically, it can be prepared as a mixture and preferably as a slurry by mixing the inorganic solid electrolyte (SE), the active material (AC), the conductive auxiliary agent (CA), the polymer binder (B), and the dispersion medium (D), and furthermore, appropriately a lithium salt and any other optionally components, by using, for example, various mixers that are usually used.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser.

The mixing condition is also not particularly limited. For example, each of the above components may be mixed collectively or may be mixed sequentially. As the mixing condition, for example, the mixing temperature can be set to 15° C. to 40° C. In addition, the rotation speed of the self-rotation type mixer or the like can be set to 200 to 3,000 rpm. The mixing atmosphere may be any atmosphere such as atmospheric air, dry air (the dew point: −20° C. or lower), or inert gas (for example, an argon gas, a helium gas, or a nitrogen gas). Since the inorganic solid electrolyte easily reacts with watery moisture, the mixing is preferably carried out under dry air or in an inert gas.

[Electrode Sheet for all-Solid State Secondary Battery]

The electrode sheet for an all-solid state secondary battery according to the embodiment of the present invention (simply, may be also referred to as an electrode sheet) is a sheet-shaped molded body with which an active material layer or electrode (a laminate of an active material layer and a collector) of an all-solid state secondary battery can be formed, and it includes various aspects depending on use applications thereof.

The electrode sheet according to the embodiment of the present invention has an active material layer formed of the above-described electrode composition according to the embodiment of the present invention. This active material layer is formed of components (excluding the dispersion medium (D)) derived from the electrode composition, in which in general, the solid particles (the inorganic solid electrolyte (SE), the active material (AC), and the conductive auxiliary agent (CA)) and the polymer binder (B) are adhered (bound) in a state of being mixedly present.

In the present invention, the conductive auxiliary agent (CA) present in the active material layer may be present as single particles or may be present as an aggregate. In any case, one preferred form is that the conductive auxiliary agent (CA) has an average particle diameter of 10 μm or less. In this form, from the viewpoint of sufficiently constructing the electron conduction path (further reducing the battery resistance) and further improving the cycle characteristics, the average particle diameter of the conductive auxiliary agent (CA) present in the active material layer is more preferably less than 1.0 μm, still more preferably 0.5 μm or less, and particularly preferably 0.4 μm or less. The lower limit of this average particle diameter is not particularly limited. However, for example, it is practically 0.05 μm or more, and it is preferably 0.06 μm or more and more preferably 0.08 μm or more. In another preferred form, the average particle diameter of the conductive auxiliary agent (CA) is the same as that in the condition (4).

The average particle diameter of the conductive auxiliary agent (CA) present in the active material layer is determined as an arithmetic average value of the area equivalent diameters of the single particles or the aggregate of the conductive auxiliary agent (CA), for example, in an SEM photographic image obtained by observing any cross section of the active material layer with a scanning electron microscope (SEM). Specifically, it shall be a value determined by the measuring method in Examples described later.

In the present invention, the active material layer preferably has an electron conductivity of 10 mS/cm or more. In a case of incorporating an active material layer having an electron conductivity of 10 mS/cm or more into an all-solid state secondary battery, it is possible to reduce the battery resistance. In terms of further reducing the battery resistance, the electron conductivity of the active material layer is more preferably 20 mS/cm or more, still more preferably 30 mS/cm or more, and particularly preferably 40 mS/cm or more. The upper limit of the electron conductivity is not particularly limited; however, it can be set to, for example, 1,000 mS/cm, and it is preferably 500 mS/cm or less and more preferably 100 mS/cm or less.

The electron conductivity of the active material layer shall be a value determined by the measuring method in Examples described later.

The electrode sheet according to the embodiment of the present invention may be any electrode sheet having an active material layer formed of the above-described electrode composition according to the embodiment of the present invention, and it may be a sheet in which the active material layer is formed on a base material (collector) or may be a sheet which does not have a base material and is formed from an active material layer. The electrode sheet is typically a sheet including the base material (collector) and the active material layer, and examples of an aspect thereof include an aspect including the base material (collector), the active material layer, and the solid electrolyte layer in this order and an aspect including the base material (collector), the active material layer, the solid electrolyte layer, and the active material layer in this order.

In addition, the electrode sheet may have another layer in addition to each of the above-described layers. Examples of the other layer include a protective layer (a peeling sheet) and a coating layer.

The base material is not particularly limited as long as it can support the active material layer, and examples thereof include a sheet body (plate-shaped body) formed of materials described later regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

At least one of the active material layers included in the electrode sheet is formed of the electrode composition according to the embodiment of the present invention. The content of each component in the active material layer formed of the electrode composition according to the embodiment of the present invention is not particularly limited; however, it is preferably synonymous with the content of each component in the solid content of the electrode composition according to the embodiment of the present invention. The layer thickness of each of the layers forming the electrode sheet according to the embodiment of the present invention is the same as the layer thickness of each of the layers described later regarding the all-solid state secondary battery.

In the present invention, each layer that constitutes a sheet for an all-solid state secondary battery may have a monolayer structure or a multilayer structure.

It is noted that in a case where the solid electrolyte layer or the active material layer is not formed of the electrode composition according to the embodiment of the present invention, it is formed of a general constitutional layer forming material.

The electrode sheet of the present invention has an active material layer that is formed of the electrode composition according to the present invention, which is an active material layer in which solid particles containing the conductive auxiliary agent (CA) and having an average particle diameter of 10 μm or less and preferably less than 1.0 μm are bound while an increase in the interface resistance of the solid particles is suppressed. As a result, in a case of using the electrode sheet for an all-solid state secondary battery according to the present invention as an active material layer of an all-solid state secondary battery, it is possible to realize an all-solid state secondary battery that has low resistance and exhibits excellent cycle characteristics. In addition, in the electrode sheet for an all-solid state secondary battery, in which the active material layer is formed on the collector, it is possible to firmly adhere the active material layer to a collector. As described above, the electrode sheet for an all-solid state secondary battery according to the present invention is suitably used as an active material layer of an all-solid state secondary battery and suitably as a sheet-shape member that forms an electrode (that is incorporated as an active material layer or an electrode).

[Manufacturing Method for Electrode Sheet for all-Solid State Secondary Battery]

A manufacturing method for an electrode sheet for an all-solid state secondary battery according to the embodiment of the present invention is not particularly limited. The electrode sheet for an all-solid state secondary battery according to the embodiment of the present invention can be manufactured by forming the active material layer using the electrode composition according to the embodiment of the present invention. Examples thereof include a method of forming a film (carrying out coating and drying) of the electrode composition according to the embodiment of the present invention on a surface of a base material (another layer may be interposed) such as a collector to form a layer (a coated and dried layer) consisting of the electrode composition. This makes it possible to produce an electrode sheet for an all-solid state secondary battery including a base material and a coated and dried layer. Here, the coated and dried layer refers to a layer formed by applying the electrode composition according to the embodiment of the present invention and drying the dispersion medium (that is, a layer formed using the electrode composition according to the embodiment of the present invention and consisting of a composition obtained by removing the dispersion medium from the electrode composition according to the embodiment of the present invention). In the active material layer and the coated and dried layer, the dispersion medium may remain within a range where the effect of the present invention is not impaired, and the residual amount thereof, for example, in a coated and dried layer may be 3% by mass or lower.

In the manufacturing method for an electrode sheet for an all-solid state secondary battery according to the embodiment of the present invention, each of the steps such as coating and drying will be described in the following manufacturing method for an all-solid state secondary battery.

In this way, it is possible to produce an electrode sheet for an all-solid state secondary battery having an active material layer that has been produced by appropriately subjecting an active material layer consisting of a coated and dried layer or a coated and dried layer to a pressurization treatment or the like. The pressurizing condition and the like will be described later in the section of the manufacturing method for an all-solid state secondary battery.

In addition, in the manufacturing method for an electrode sheet for an all-solid state secondary battery according to the embodiment of the present invention, the base material, the protective layer (particularly a peeling sheet), or the like can also be peeled.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) that constitutes an all-solid state secondary battery may have a monolayer structure or a multilayer structure.

In the all-solid state secondary battery according to the embodiment of the present invention, it is preferable that at least one layer of the negative electrode active material layer or the positive electrode active material layer is formed of the electrode composition according to the aspect of the present invention and at least the positive electrode active material layer is formed of the electrode composition according to the aspect of the present invention. In addition, an aspect in which both the negative electrode active material layer and the positive electrode active material layer are formed of the electrode composition according to the embodiment of the present invention is also one of the preferred aspects. In addition, it is preferable that any one of the negative electrode (a laminate of a negative electrode collector and a negative electrode collector) and the positive electrode (a laminate of a positive electrode collector and a positive electrode collector), preferably the positive electrode is formed of the electrode sheet for an all-solid state secondary battery according to the embodiment of the present invention, and an aspect in which both of them are formed of the electrode sheet for an all-solid state secondary battery according to the present invention is also one of the preferred aspects.

In the active material layer formed of the electrode composition according to the embodiment of the present invention, it is preferable that the kinds of components to be included and the content thereof are the same as those of the solid content of the electrode composition according to the embodiment of the present invention.

It is noted that in a case where the active material layer is not formed of the electrode composition according to the embodiment of the present invention, the active material layer and the solid electrolyte layer can be produced using known materials.

<Positive Electrode Active Material Layer and Negative Electrode Active Material Layer>

The thickness of each of the negative electrode active material layer and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

The active material layer having the above-described thickness may be a single layer (single application of an electrode composition) or may be a plurality of layers (a plurality of times of application of an electrode composition). However, in terms of resistance reduction and productivity, it is preferable to form, as a single layer, an active material layer having a large layer thickness using the electrode composition according to the embodiment of the present invention, which enables layer thickening by increasing the concentration. The layer thickness of the layer-thickened single-layer active material, which can be preferably formed with the electrode composition according to the embodiment of the present invention, can be set to, for example, 70 μm or more and can also be set to furthermore, 100 μm or more.

In a case where the negative electrode active material layer or the positive electrode active material layer is formed of the electrode composition according to the embodiment of the present invention, each of the active material layers is the same as the active material layer in the electrode sheet for an all-solid state secondary battery according to the embodiment of the present invention.

<Solid Electrolyte Layer>

The solid electrolyte layer is formed using a known material that is capable of forming a solid electrolyte layer of an all-solid state secondary battery, which is the same as the solid electrolyte of the all-solid state secondary battery. The thickness thereof is not particularly limited; however, it is preferably 10 to 1,000 μm, and more preferably 20 μm or more and less than 500 μm.

<Collector>

It is preferable that each of the positive electrode active material layer and the negative electrode active material layer includes a collector on the side opposite to the solid electrolyte layer. Such a positive electrode collector and such a negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

The material that forms the negative electrode collector is preferably, in addition to aluminum, copper, a copper alloy, stainless steel, nickel, titanium, and the like, a material obtained by treating the surface of aluminum, copper, a copper alloy, or stainless steel with carbon, nickel, titanium, or silver, and it is more preferably aluminum, copper, a copper alloy, or stainless steel.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is; however, it is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

<Preferred Embodiment of all-Solid State Secondary Battery>

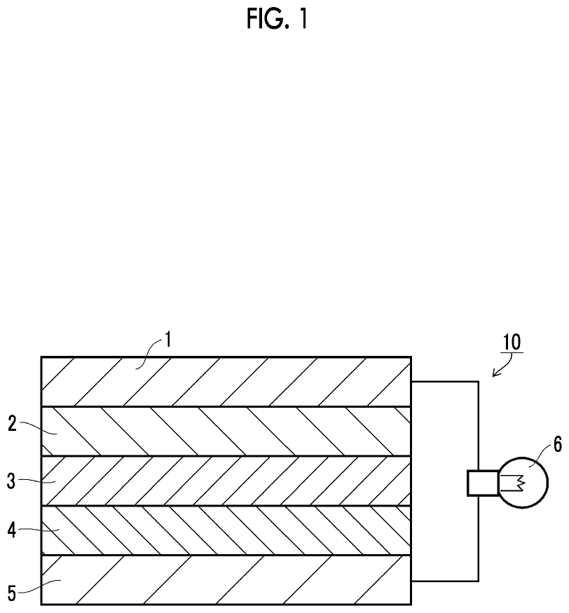

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is placed in a 2032-type coin case, the all-solid state secondary battery will be referred to as a laminate for an all-solid state secondary battery, and a battery produced by placing this laminate for an all-solid state secondary battery in a 2032-type coin case will be referred to as a (coin-type) all-solid state secondary battery, whereby both batteries may be distinctively referred to in some cases.

(Solid Electrolyte Layer)

As the solid electrolyte layer, a solid electrolyte layer in the related art, which is applied to an all-solid state secondary battery, can be used without particular limitation. This solid electrolyte layer appropriately contains an inorganic solid electrolyte having an ion conductivity of a metal belonging to Group 1 or Group 2 in the periodic table, any component described above, and the like, and it generally does not contain an active material.

(Positive Electrode Active Material Layer and Negative Electrode Active Material Layer)

In the all-solid state secondary battery 10, both the positive electrode active material layer and the negative electrode active material layer are formed of the electrode composition according to the embodiment of the present invention. Preferably, the positive electrode in which the positive electrode active material layer and the positive electrode collector are laminated, and the negative electrode in which the negative electrode active material layer and the negative electrode collector are laminated are formed of the electrode sheet according to the embodiment of the present invention, to which a collector is applied as a base material.

The positive electrode active material layer contains the inorganic solid electrolyte (SE) having an ion conductivity of a metal belonging to Group 1 or Group 2 in the periodic table, a positive electrode active material, the polymer binder (B), and the conductive auxiliary agent (CA), and any component described above and the like within a range where the effect of the present invention is not impaired.

The negative electrode active material layer contains the inorganic solid electrolyte (SE) having an ion conductivity of a metal belonging to Group 1 or Group 2 in the periodic table, a negative electrode active material, the polymer binder (B), and the conductive auxiliary agent (CA), and any component described above and the like within a range where the effect of the present invention is not impaired. In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above-described thickness of the above negative electrode active material layer.

The kinds of the respective components contained in the positive electrode active material layer 4, the solid electrolyte layer 3, and the negative electrode active material layer 2, particularly the kinds of the inorganic solid electrolyte, the conductive auxiliary agent, and the polymer binder may be the same or different from each other.

In the present invention, in a case of forming the active material layer with the electrode composition according to the embodiment of the present invention, it is possible to realize an all-solid state secondary battery having low resistance and excellent cycle characteristics.

(Collector)

The positive electrode collector 5 and the negative electrode collector 1 are as described above.

In a case where the all-solid state secondary battery 10 has a constitutional layer other than the constitutional layer formed of the electrode composition according to the embodiment of the present invention, a layer formed of a known constitutional layer forming material can also be applied.

In addition, each layer may be composed of a single layer or multiple layers.

[Manufacture of all-Solid State Secondary Battery]

The all-solid state secondary battery can be manufactured according to a conventional method. Specifically, the all-solid state secondary battery can be manufactured by forming at least one active material layer by using the electrode composition according to the embodiment of the present invention or the like, and then forming a solid electrolyte layer and appropriately the other active material layer or an electrode by using the known materials.

Specifically, the all-solid state secondary battery according to the embodiment of the present invention can be manufactured by carrying out a method (a manufacturing method for an electrode sheet for an all-solid state secondary battery according to the embodiment of the present invention) which includes (is carried out through) a step of appropriately coating and drying on a surface of a base material (for example, a metal foil serving as a collector) with the electrode composition according to the embodiment of the present invention to form a coating film (form a film).

For example, an electrode composition which contains a positive electrode active material and serves as a positive electrode material (a positive electrode composition) is applied onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Further, the electrode composition containing a negative electrode active material as a negative electrode material (a negative electrode composition) is formed into a film on the solid electrolyte layer to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by sealing the all-solid state secondary battery in a housing.

In addition, it is also possible to manufacture an all-solid state secondary battery by carrying out the forming method of each layer in reverse order to form a negative electrode active material layer, a solid electrolyte layer, and a positive electrode active material layer on a negative electrode collector and overlaying a positive electrode collector thereon.

As another method, the following method can be exemplified. That is, the positive electrode sheet for an all-solid state secondary battery is produced as described above. In addition, an electrode composition which contains a negative electrode active material and serves as a negative electrode material (a negative electrode composition) is formed into a film on a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated such that the solid electrolyte layer removed from the base material is sandwiched therebetween. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this way, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this way, an all-solid state secondary battery can be manufactured. The pressurizing method and the pressurizing conditions in this method are not particularly limited, and a method and pressurizing conditions described in the pressurization step, which will be described later, can be applied.

The active material layer or the like can also be formed on the substrate or the active material layer, for example, by pressure-molding the electrode composition or the like under a pressurizing condition described later, or the solid electrolyte or a sheet molded body of the active material.

In the above-described manufacturing method, it suffices that the electrode composition according to the embodiment of the present invention is used for any one of the positive electrode composition or the negative electrode composition, and the electrode composition according to the embodiment of the present invention can also be used for both the positive electrode composition and the negative electrode composition.

<Formation (Film Formation) of Each Layer>

The coating method for each composition is not particularly limited and can be appropriately selected. Examples thereof include wet-type coating methods such as coating (preferably wet-type coating), spray coating, spin coating, dip coating, slit coating, stripe coating, and bar coating. The coating temperature is not particularly limited, and examples the range thereof include a temperature range of usually room temperature (for example, 15° C. to 30° C.) under non-heating.

The applied composition is preferably subjected to a drying treatment (a heating treatment). The drying treatment may be carried out each time after the composition is applied or may be carried out after it is subjected to multilayer application. The drying temperature is not particularly limited as long as the dispersion medium can be removed, and it is appropriately set according to the boiling point of the dispersion medium. The lower limit of the drying temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. In a case where the electrode composition according to the embodiment of the present invention is applied and dried in this way, it is possible to suppress the variation in the contact state and bind solid particles, and furthermore, it is possible to form a coated and dried layer having a flat surface.

After applying each composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing methods include a method using a hydraulic cylinder press machine. The pressurizing force is not particularly limited; however, it is generally preferably in a range of 5 to 1,500 MPa.

In addition, each of the applied compositions may be heated while being pressurized. The heating temperature is not particularly limited; however, it is generally in a range of 30° C. to 300° C. The press can also be applied at a temperature higher than the glass transition temperature of the inorganic solid electrolyte. It is also possible to carry out pressing at a temperature higher than the glass transition temperature of the polymer that constitutes a polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out the transfer.

The atmosphere in the film forming method (coating, drying, and pressurization (under heating) is not particularly limited and may be any atmosphere such as atmospheric air, dry air (the dew point: −20° C. or lower), or inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the electrode sheet for an all-solid state secondary battery, for example, the all-solid state secondary battery, it is also possible to use a restraining device (screw fastening pressure or the like) of the all-solid state secondary battery in order to continuously apply an intermediate pressure. The pressing pressure may be a pressure that is constant or varies with respect to a portion under pressure such as a sheet surface. The pressing pressure may be variable depending on the area or the film thickness of the portion under pressure. In addition, the pressure may also be variable stepwise for the same portion. A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

1. Polymer Synthesis

Polymers B-1 to B-21 respectively represented by the following chemical formulae were synthesized as follows to prepare binder solutions or dispersion liquids B-1 to B-21 containing the respective polymers.

### [Synthesis Example B-1] Synthesis of Polymer B-1 and Preparation of Binder Solution B-1

To a 100 mL volumetric flask, 90 g of dodecyl acrylate (manufactured by Tokyo Chemical Industry Co., Ltd.), 10 g of 2-methoxyethyl methacrylate (manufactured by Tokyo Chemical Industry Co., Ltd.), and 3.6 g of a polymerization initiator V-601 (product name, manufactured by FUJIFILM Wako Pure Chemical Corporation) were added and then dissolved in 36 g of butyl butyrate to prepare a monomer solution. To a 300 mL three-neck flask, 18 g of butyl butyrate was added and stirred at 80° C., and then the above-described monomer solution was added dropwise thereto over 2 hours. After completion of the dropwise addition, the temperature was raised to 90° C., and stirring was carried out for 2 hours to synthesize a polymer B-1 (an acrylic polymer). The obtained solution was reprecipitated in methanol and redissolved in xylene.

In this way, an acrylic polymer B-1 having a mass average molecular weight of 400,000 was synthesized to prepare a binder solution B-1 (concentration: 10% by mass) consisting of this polymer.

### [Synthesis Example B-2]: Synthesis of Polymer B-2 and Preparation of Binder Solution B-2

Specifically, 300 g of cyclohexane as a solvent and 1.0 mL of sec-butyl lithium (1.3 M, manufactured by FUJIFILM Wako Pure Chemical Corporation) as a polymerization initiator were charged into a pressure-resistant container that had been subjected to nitrogen substitution and drying, and after raising the temperature to 50° C., 15.5 g of styrene was added thereto carry out polymerization for 2 hours, 24.0 g of 1,3-butadiene and 45.0 g of ethylene were subsequently added thereto carry out polymerization for 3 hours, and then 15.5 g of styrene was added thereto carry out polymerization for 2 hours. The obtained solution was reprecipitated in methanol and dried to obtain a solid, and 3 parts by mass of 2,6-di-t-butyl-p-cresol was added with respect to 100 parts by mass of the polymer obtained solid, and then the reaction was carried out at 180° C. for 5 hours. The obtained solution was reprecipitated in acetonitrile, and the obtained solid was dried at 80° C. to obtain a polymer (a dry solid product). Then, in a pressure-resistant container, the entire amount of the polymer obtained as above was dissolved in 400 parts by mass of cyclohexane, and then 5% by mass of palladium carbon (palladium carrying amount: 5% by mass) with respect to the above-described polymer was added as a hydrogenation catalyst, and the mixture was subjected to a reaction under the conditions of a hydrogen pressure of 2 MPa and 150° C. for 10 hours. After cooling and pressure release, palladium carbon was removed by filtration, and the filtrate was concentrated and further vacuum dried to obtain a hydrocarbon polymer B-2.

Then, it was dissolved in xylene to prepare a binder solution B-2 (concentration: 10% by mass).

### [Synthesis Example B-3]: Synthesis of Polymer B-3 and Preparation of Binder Solution B-3

100 parts by mass of ion exchange water, 64 parts by mass of vinylidene fluoride, 17 parts by mass of hexafluoropropene, and 19 parts by mass of tetrafluoroethylene were added to an autoclave, and 1 part by mass of a polymerization initiator PEROYL IPP (product name, chemical name: diisopropyl peroxydicarbonate, manufactured by NOF CORPORATION) was further added thereto and stirred at 40° C. for 24 hours. After stirring, the precipitate was filtered and dried at 100° C. for 10 hours. 150 parts by mass of toluene or N-methylpyrrolidone was added with respect to 10 parts by mass of the obtained polymer and dissolved.

In this manner, a fluoropolymer B-3 as a random copolymer was synthesized to prepare a binder solution B-3 (concentration: 10% by mass) consisting of this polymer.

### [Synthesis Example B-4]: Synthesis of Polymer B-4 and Preparation of Binder Solution B-4

To a 100 mL volumetric flask, 9.9 g of methyl methacrylate (manufactured by Tokyo Chemical Industry Co., Ltd.), 90 g of dodecyl acrylate (manufactured by Tokyo Chemical Industry Co., Ltd.), 0.07 g of maleic acid anhydride (manufactured by Tokyo Chemical Industry Co., Ltd.), 0.03 g of monomethyl maleate, and 3.6 g of a polymerization initiator V-601 (product name, manufactured by FUJIFILM Wako Pure Chemical Corporation) were added and then dissolved in 36 g of butyl butyrate to prepare a monomer solution. To a 300 mL three-neck flask, 18 g of butyl butyrate was added and stirred at 80° C., and then the above-described monomer solution was added dropwise thereto over 2 hours. After completion of the dropwise addition, the temperature was raised to 90° C., and stirring was carried out for 2 hours to synthesize a polymer B-4 (an acrylic polymer). The obtained solution was reprecipitated in acetonitrile and redissolved in xylene.

In this way, an acrylic polymer B-4 having a mass average molecular weight of 400,000 was synthesized to prepare a binder solution B-4 (concentration: 10% by mass) consisting of this polymer.

### Synthesis Examples B-5 to 9, 11, 12, 14, and 19

Synthesis of polymers B-5 to 9, 11, 12, 14, and 19, and preparation of binder solutions B-5 to 9, 11, 12, 14, and 19

Acrylic polymers B-5 to 9, 11, 12, 14, and 19 were synthesized in the same manner as in Synthesis Example B-4, thereby preparing binder solutions B-5 to 9, 11, 12, 14, and 19 (concentration: 10% by mass) consisting of the respective acrylic polymers, except that in Synthesis Example B-4, a compound from which each constitutional component was derived was used so that the structure and the composition (the content of the constitutional component) shown in the following structural formula was obtained.

### Synthesis Example B-10: Synthesis of Polymer B-10 and Preparation of Binder Dispersion Liquid B-10

To a 1 L graduated cylinder, 200 g of n-butyl acrylate, 200 g of methacrylic acid, 16.5 g of 3-mercaptopropionic acid, and 7.8 g of a polymerization initiator V-601 (manufactured by FUJIFILM Wako Pure Chemical Corporation) were added and stirred to be uniformly dissolved, whereby a monomer solution was prepared. To a 2 L three-neck flask, 465.5 g of toluene (manufactured by FUJIFILM Wako Pure Chemical Corporation) was added and stirred at 80° C., and then the above-described monomer solution was added dropwise thereto over 2 hours. After completion of the dropwise addition, stirring was carried out at 80° C. for 2 hours, and then the temperature was raised to 90° C., and stirring was carried out for 2 hours. Next, 275 mg of 2,2,6,6-tetramethylpiperidine 1-oxyl (manufactured by FUJIFILM Wako Pure Chemical Corporation), 27.5 g of glycidyl methacrylate (manufactured by Tokyo Chemical Industry Co., Ltd.), and 5.5 g of tetrabutylammonium bromide (manufactured by FUJIFILM Wako Pure Chemical Corporation) were added thereto, and the mixture was stirred at 120° C. for 3 hours. After allowing the solution to stand at room temperature, it was poured into 1,800 g of methanol to remove the supernatant. Butyl butyrate was added thereto, and methanol was distilled off under reduced pressure to obtain a butyl butyrate solution of a macromonomer M-1 (number average molecular weight: 12,000). The concentration of solid contents thereof was 49% by mass.

To a 100 mL graduated cylinder, 28.8 g of methoxyethyl methoxyethyl (manufactured by Tokyo Chemical Industry Co., Ltd.) and 1.40 g of a polymerization initiator V-601 (product name, manufactured by FUJIFILM Wako Pure Chemical Corporation) were added and then dissolved in 28.8 g of butyl butyrate to prepare a monomer solution.

To a 300 mL three-necked flask, 19.6 g of a macromonomer M-1 solution and 36.0 g of butyl butyrate were added and stirred at 80° C., and then the above-described monomer solution was added dropwise thereto over 2 hours. After the completion of the dropwise addition, the solution was heated to 90° C. and stirred for 2 hours.

Then, it was mixed with xylene and dispersed in the form of particles to prepare a binder dispersion liquid B-10 (concentration: 10% by mass) of the acrylic polymer B-10. The average particle diameter of the acrylic polymer B-10 in the dispersion liquid was 200 nm.

### [Synthesis Example B-13] Synthesis of Polymer B-13 and Preparation of Binder Solution B-13

An acrylic polymer B-13 was synthesized in the same manner as in Synthesis Example B-1 to prepare a binder solution B-13 (concentration: 10% by mass), except that in Synthesis Example B-1, 99.7 g of dodecyl acrylate and 0.3 g of methacrylate (manufactured by Tokyo Chemical Industry Co., Ltd.) were used instead of 90 g of dodecyl acrylate and 2-methoxyethyl acrylate.

### [Synthesis Example B-15] Synthesis of Polymer B-15 and Preparation of Binder Solution B-15

An acrylic polymer B-15 was synthesized in the same manner as in Synthesis Example B-1 to prepare a binder solution B-15 (concentration: 10% by mass) consisting of this polymer, except that in Synthesis Example B-1, 0.5 g of AS-6 (product name, a styrene macromonomer, number average molecular weight: 6,000, manufactured by TOAGOSEI Co., Ltd.) was used and the amount of 2-methoxyethyl acrylate was set to 9.5 g.

### [Synthesis Example B-16] Synthesis of Polymer B-16 and Preparation of Binder Solution B-16

To a 100 mL volumetric flask, 2.7 g of 2-hydroxyethyl methacrylate (manufactured by Tokyo Chemical Industry Co., Ltd.), 0.1 g of monomethyl maleate (manufactured by Tokyo Chemical Industry Co., Ltd.), 0.2 g of maleic acid anhydride (manufactured by Tokyo Chemical Industry Co., Ltd.), 77 g of dodecyl acrylate, and 1.8 g of a polymerization initiator V-601 (product name, manufactured by FUJIFILM Wako Pure Chemical Corporation) were added and then dissolved in 36 g of butyl butyrate to prepare a monomer solution. To a 300 mL three-neck flask, 18 g of butyl butyrate was added and stirred at 80° C., and then the above-described monomer solution was added dropwise thereto over 2 hours. After the completion of the dropwise addition, the solution was heated to 90° C. and stirred for 2 hours. Thereafter, 20 g of methyl methacrylate and 1.8 g of the polymerization initiator V-601 were added thereto, and the resultant mixture was stirred at 90° C. for 2 hours. The obtained solution was reprecipitated in acetonitrile and redissolved in xylene.

In this way, an acrylic polymer B-16 which is an ABA type block polymer was synthesized to prepare a binder solution B-16 (concentration: 10% by mass) consisting of this polymer.

### [Synthesis Example B-17] Synthesis of Polymer B-17 and Preparation of Binder Solution B-17

An acrylic polymer B-17 was synthesized in the same manner as in Synthesis Example B-1 to prepare a binder solution B-17 (concentration: 10% by mass) consisting of this polymer, except that in Synthesis Example B-1, 97 g of dodecyl acrylate, 2.7 g of 2-hydroxyethyl methacrylate, 0.1 g of monomethyl maleate, and 0.2 g of maleic acid anhydride were used.

### [Synthesis Example B-18] Synthesis of Polymer B-18 and Preparation of Binder Solution B-18

A macromonomer M-2 (number average molecular weight: 15,000) was synthesized in the same manner as in the synthesis example of the macromonomer M-1, except that in the synthesis of the macromonomer M-1 in Synthesis Example B-10, 420 g of dodecyl acrylate, 40 g of maleic acid anhydride, and 40 g of monomethyl maleate were used instead of n-butyl acrylate and methacrylate.

An acrylic polymer B-18 was synthesized in the same manner as in Synthesis Example B-10 to prepare a binder solution B-18 (concentration: 10% by mass) consisting of this polymer, except that in Synthesis Example B-10, 72 g of dodecyl acrylate and 3 g of 2-hydroxyethyl methacrylate were used instead of methoxyethyl methacrylate, and 25 g (solid content amount) of the macromonomer M-2 was used instead of the macromonomer M-1 solution.

### [Synthesis Example B-20] Synthesis of Polymer B-20 and Preparation of Binder Solution B-20

An acrylic polymer B-20 was synthesized in the same manner as in Synthesis Example B-1 to prepare a binder solution B-20 (concentration: 10% by mass) consisting of this polymer, except that in Synthesis Example B-1, 90 g of dodecyl acrylate, 9.91 g of methyl methacrylate, and 0.09 g of monomethyl maleate were used.

### [Synthesis Example B-21] Synthesis of Polymer B-21 and Preparation of Binder Solution B-21

An acrylic polymer B-21 was synthesized in the same manner as in Synthesis Example B-1 to prepare a binder solution B-21 (concentration: 10% by mass) consisting of this polymer, except that in Synthesis Example B-1, 84.7 g of dodecyl acrylate, 15 g of styrene, and 0.3 g of monomethyl maleate were used.

Each of the polymers synthesized is shown below. The polymer B-16 is a block polymer, and it is denoted in the same manner as described above. The number at the bottom right of each constitutional component indicates the content (% by mass), x in the polymer B-4 and the like is a value that satisfies “Content of functional group (a)” shown in Table 1, and x in the polymer B-16 a value for indicating the ratio of the content of each of the both end blocks. In the following structural formulae, Me represents a methyl group.

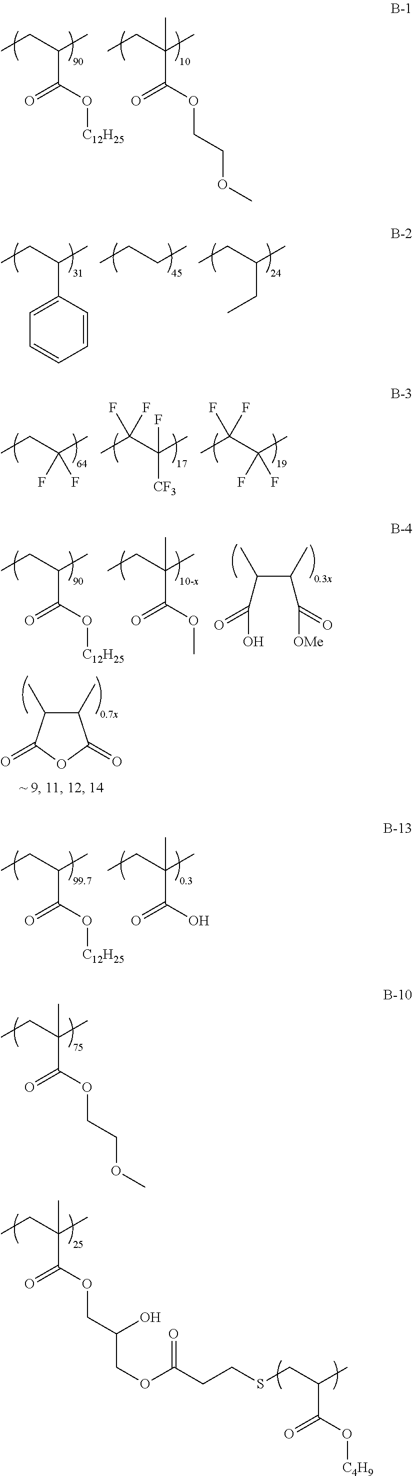

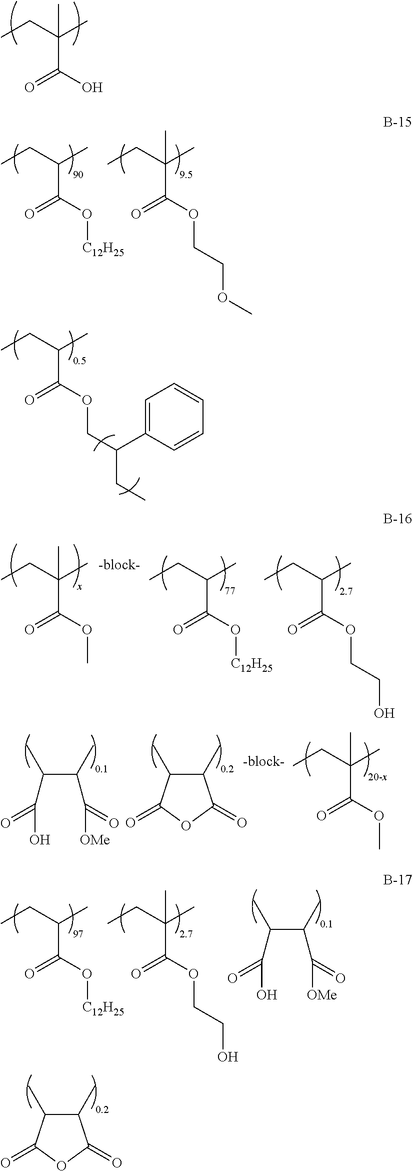

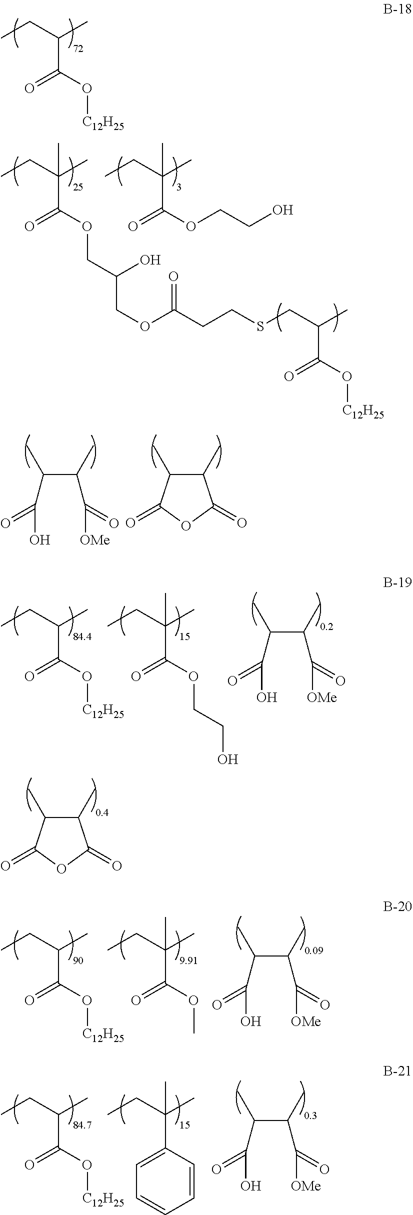

The mass average molecular weight (Mw) and SP value of each synthesized polymer were calculated based on the above-described methods. These results are shown in Table 1. It is noted that the unit of the SP value is omitted in the table, the unit of which is “MPa^{1/2}”.

It is noted that “Content (% by mass)” in Table 1 indicates the content of each functional group in terms of the content of the functional group-containing constitutional component in the polymer (b). In addition, since one functional group-containing constitutional component of the polymer B-18 has a carboxy group and a carboxylic acid anhydride group as the functional group (a), the content of the functional group (a) was defined as the content of the one functional group-containing constitutional component in the polymer (b).

In Table 1, “x” in the chemical formulae was added. However, since x is known in the polymer B-16, it is indicated by “-” in the corresponding column.

TABLE 1

| | Functional group-containing constitutional component | | | | |
|---|---|---|---|---|---|
| Binder | | Content (% by | | Mass average molecular | SP |
| No. | Functional group (a) | mass) | x | weight | value |
| B-1 | Ether bond | 10 | — | 400,000 | 18.9 |
| B-2 | Allyl group | 31 | — | 120,000 | 17.8 |
| B-3 | — | — | — | 450,000 | 12.0 |
| B-4 | Carboxy group/carboxylic acid anhydride group | 0.03/0.07 | 0.10 | 400,000 | 18.9 |
| B-5 | Carboxy group/carboxylic acid anhydride group | 0.09/0.21 | 0.30 | 400,000 | 18.9 |
| B-6 | Carboxy group/carboxylic acid anhydride group | 0.15/0.35 | 0.50 | 400,000 | 18.9 |
| B-7 | Carboxy group/carboxylic acid anhydride group | 0.3/0.7 | 1.00 | 400,000 | 18.9 |
| B-8 | Carboxy group/carboxylic acid anhydride group | 0.6/1.4 | 2.00 | 400,000 | 18.9 |
| B-9 | Carboxy group/carboxylic acid anhydride group | 3/7 | 10 | 400,000 | 19.0 |
| B-10 | Carboxy group/ester bond | 25/75 | — | 400,000 | 21.7 |
| B-11 | Carboxy group/carboxylic acid anhydride group | 0.09/0.21 | 0.3 | 5,000 | 18.9 |
| B-12 | Carboxy group/carboxylic acid anhydride group | 0.09/0.21 | 0.3 | 6,000 | 18.9 |
| B-13 | Carboxy group | 0.3 | — | 400,000 | 18.9 |
| B-14 | — | — | 0 | 1,500,000 | 18.9 |
| B-15 | Ether bond/allyl group | 9.5/0.5 | — | 400,000 | 18.3 |
| B-16 | Hydroxy group/carboxy group/carboxylic acid | 2.7/0.1/0.2 | — | 400,000 | 18.6 |
| | anhydride group | | | | |
| B-17 | Hydroxy group/carboxy group/carboxylic acid | 2.7/0.1/0.2 | — | 400,000 | 18.9 |
| | anhydride group | | | | |
| B-18 | Hydroxy group/(carboxy group + carboxylic acid | 3/25 | — | 420,000 | 18.6 |
| | anhydride group) | | | | |
| B-19 | Hydroxy group/carboxy group/carboxylic acid | 15/0.2/0.4 | — | 400,000 | 19.8 |
| | anhydride group | | | | |
| B-20 | Carboxy group | 0.09 | — | 400,000 | 18.9 |
| B-21 | Ally group/carboxy group | 15/0.3 | — | 400,000 | 18.8 |

2. Synthesis of Sulfide-Based Inorganic Solid Electrolyte

### Synthesis Example 5

A sulfide-based inorganic solid electrolyte was synthesized with reference to the non-patent documents of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling (micronization) was carried out at a temperature of 25° C. and a rotation speed of 510 rpm for 24 hours, thereby obtaining yellow powder (6.20 g) of a sulfide-based inorganic solid electrolyte (Li—P—S-based glass, hereinafter, may be denoted as LPS).

In this manner, an inorganic solid electrolyte LPS having a particle diameter of 5 m was synthesized.

### Example 1

<Preparation of Positive Electrode Composition (Slurry)>

2.8 g of the inorganic solid electrolyte (SE) shown in Table 2-1 and xylene having the following isomer mixing ratio as the dispersion medium (D) were put into a container for a self-rotation type mixer (ARE-310, manufactured by THINKY CORPORATION) so that the content of the dispersion medium in the positive electrode composition was 50% by mass. Then, this container was set in the self-rotation type mixer ARE-310 (product name), and mixing was carried out for 2 minutes at a temperature of 25° C. and a rotation speed of 2,000 rpm. Then, LiNi_{1/3}Co_{1/3}Mn_{1/3}O₂ (NMC, manufactured by Sigma-Aldrich Co., LLC) as the positive electrode active material (AC), acetylene black (AB) as the conductive auxiliary agent (CA), and the binder solution (B) or binder dispersion liquid shown in Table 2-1 (denoted as “Binder solution or Dispersion liquid” in Table 2-1) were put into this container at a proportion which leads to the content shown in Table 2-1, the container was set in a self-rotation type mixer ARE-310 (product name), and mixing was carried out for 2 minutes under the conditions of 25° C. and a rotation speed of 2,000 rpm to prepare each of positive electrode compositions (slurries) P-1 to P-24. It is noted that the content of the binder solution or the dispersion liquid is a content in the solid content.

<Preparation of Negative Electrode Composition (Slurry)>

2.8 g of the inorganic solid electrolyte (SE) shown in Table 3-1, 0.06 g (in terms of solid content mass) of the binder solution (B) or dispersion liquid shown in Table 3-1 (denoted as “Binder solution or Dispersion liquid” in Table 3-1), and xylene having the following isomer mixing ratio as the dispersion medium (D) were put into a container for a self-rotation type mixer (ARE-310) so that the content of the dispersion medium (D) in the negative electrode composition was 50% by mass. Then, this container was set in the self-rotation type mixer ARE-310 (product name) manufactured by THINKY CORPORATION, and mixing was carried out for 2 minutes under the conditions of 25° C. and the rotation speed of 2,000 rpm. Then, 3.11 g of silicon (Si, manufactured by Sigma-Aldrich Co., LLC) as the negative electrode active material (AC) shown in Table 3-1 and 0.25 g of acetylene black (AB) as the conductive auxiliary agent (CA) were put into the container, the container was set in the same manner in the self-rotation type mixer ARE-310 (product name), and mixing was carried out for 2 minutes under the conditions of 25° C. and the rotation speed of 2,000 rpm to prepare each of negative electrode compositions (slurries) N-1 to N-24.

It is noted that in the negative electrode composition (slurry) N-19, 2.86 g of the inorganic solid electrolyte (SE) is used, and the binder solution (B) is not used.

The adsorption rate [A_{CA}] of the polymer binder (B) with respect to the conductive auxiliary agent (CA) and the adsorption rate [A_{SE}] thereof with respect to the inorganic solid electrolyte (SE), where the polymer binder (B) had been used in the preparation of the electrode composition, were each measured using the above-described measuring method, and the measured values are shown Table 2-2 and Table 3-2.

In addition, the average particle diameter (the condition (4A)) of the conductive auxiliary agent (CA) in a case of mixing the polymer binder (B), the dispersion medium (D), and the conductive auxiliary agent (CA), where the kinds and mass proportions thereof were the same as those in the electrode composition was measured as follows. That is, the polymer binder (B), the dispersion medium (D), and the conductive auxiliary agent (CA), which had been used in the preparation of each electrode composition, were mixed at the mass proportion shown in Table 2-1 or Table 3-1 to prepare a dispersion liquid for measurement. The preparation conditions were such conditions of room temperature, a rotation speed of 50 rpm, and a stirring time of 3 hours by using a mix rotor (manufactured by AS ONE Corporation). Using the obtained dispersion liquid for measurement, data collection was carried out 50 times by using a laser scattering-type particle size distribution analyzer LA-920 (product name, manufactured by Horiba Ltd.) and using a quartz cell for measurement at a temperature of 25° C., and calculation was carried out to obtain the volume average particle diameter. Regarding other detailed conditions and the like, the description of JIS Z 8828:2013 “particle diameter analysis-Dynamic light scattering method” was referred to as necessary. For each level, five samples were prepared and measured, and the average value thereof was adopted as the average particle diameter of the conductive auxiliary agent (CA) (the condition (4A)). The results are shown in the column of “Condition (4A) average particle diameter” of Table 2-2 and Table 3-2.

Further, the SP value of the dispersion medium (D) and the difference ΔSP (in terms of absolute value) between the SP value of the dispersion medium (D) and the SP value of the polymer (b) that forms the polymer binder (B) were calculated and are shown in the respective tables.

It is noted that regarding the combination of the polymer binder (B) and the dispersion medium (D) used in the preparation of the electrode compositions shown in Table 2-1 and Table 3-1 below, as a result of determining the solubility of the polymers B-1 to B-9, B-11 to B-21 synthesized as above, in the dispersion medium (D), according to the transmittance measurement described above, the solubility was 10% by mass or more in any case, which was indicated as “Soluble” in the column of “Solubility” of Table 2-2 and Table 3-2. On the other hand, the solubility of the polymer B-10 was less than 10% by mass, which was indicated as “Particulate” in the column of “Solubility” of Table 2-2 and Table 3-2.

It is noted that in each table, the unit of the content (% by mass), the unit of the SP value, the unit of the difference ΔSP in the SP value (MPa^{1/2}), the unit of the adsorption rate (%), and the unit of the average particle diameter (in) are omitted.

TABLE 2-1

| | | | | | | | Binder solution or | | | Dispersion | |
|---|---|---|---|---|---|---|---|---|---|---|---|
| | Positive electrode | | Inorganic solid | | Conductive auxiliary | | dispersion liquid | | | medium (D) | |
| Composition | active material (AC) | | electrolyte (SE) | | agent (CA) | | | SP | | | SP |
| No. | Kind | Content | Kind | Content | Kind | Content | No. | value | Content | Kind | value |
| P-1 | NMC | 75 | LPS | 21 | AB | 3 | B-1 | 18.9 | 1 | Xylene | 18.7 |
| P-2 | NMC | 75 | LPS | 21 | AB | 3 | B-2 | 17.8 | 1 | Xylene | 18.7 |
| P-3 | NMC | 75 | LPS | 21 | AB | 3 | B-3 | 12.0 | 1 | Xylene | 18.7 |
| P-4 | NMC | 75 | LPS | 21 | AB | 3 | B-4 | 18.9 | 1 | Xylene | 18.7 |
| P-5 | NMC | 75 | LPS | 21 | AB | 3 | B-5 | 18.9 | 1 | Xylene | 18.7 |
| P-6 | NMC | 75 | LPS | 21 | AB | 3 | B-6 | 18.9 | 1 | Xylene | 18.7 |
| P-7 | NMC | 75 | LPS | 21 | AB | 3 | B-7 | 18.9 | 1 | Xylene | 18.7 |
| P-8 | NMC | 75 | LPS | 21 | AB | 3 | B-8 | 18.9 | 1 | Xylene | 18.7 |
| P-9 | NMC | 75 | LPS | 21 | AB | 3 | B-9 | 19.0 | 1 | Xylene | 18.7 |
| P-10 | NMC | 75 | LPS | 21 | AB | 3 | B-10 | 21.7 | 1 | Xylene | 18.7 |
| p-11 | NMC | 75 | LPS | 21 | AB | 3 | B-11 | 18.9 | 1 | Xylene | 18.7 |
| P-12 | NMC | 75 | LPS | 21 | AB | 3 | B-12 | 18.9 | 1 | Xylene | 18.7 |
| P-13 | NMC | 75 | LPS | 21 | AB | 3 | B-13 | 18.9 | 1 | Xylene | 18.7 |
| P-14 | NMC | 75 | LPS | 21 | AB | 3 | B-14 | 18.9 | 1 | Xylene | 18.7 |
| P-15 | NMC | 75 | LPS | 21 | AB | 3 | B-15 | 18.3 | 1 | Xylene | 18.7 |
| P-16 | NMC | 75 | LPS | 21 | AB | 3 | B-16 | 18.6 | 1 | Xylene | 18.7 |
| P-17 | NMC | 75 | LPS | 21 | AB | 3 | B-17 | 18.9 | 1 | Xylene | 18.7 |
| P-18 | NMC | 75 | LPS | 21 | AB | 3 | B-18 | 18.6 | 1 | Xylene | 18.7 |
| P-19 | NMC | 75 | LPS | 22 | AB | 3 | — | — | — | Xylene | 18.7 |
| P-20 | NMC | 75 | LPS | 21 | AB | 3 | B-19 | 19.8 | 1 | Xylene | 18.7 |
| P-21 | NMC | 75 | LPS | 21 | AB | 3 | B-20 | 18.9 | 1 | Xylene | 18.7 |
| P-22 | NMC | 75 | LPS | 21 | AB2 | 3 | B-18 | 18.6 | 1 | Xylene | 18.7 |
| P-23 | NMC | 75 | LPS | 21 | AB | 3 | B-21 | 18.8 | 1 | Xylene | 18.7 |
| P-24 | NMC | 75 | LPS | 21 | CB | 3 | B-18 | 18.6 | 1 | Xylene | 18.7 |

TABLE 2-2

| | Difference | | Adsorption | Adsorption | Condition (4A) | |
|---|---|---|---|---|---|---|
| Composition | in SP | | rate | rate | Average particle | |
| No. | value | Solubility | [A_{CA}] | [A_{SE}] | diameter | Note |
| P-1 | 0.2 | Dissolved | 0 | 0 | 0.9 | Comparative |
| | | | | | | Example |
| P-2 | 0.9 | Dissolved | 55 | 0 | 28 | Comparative |
| | | | | | | Example |
| P-3 | 6.7 | Dissolved | 0 | 0 | 0.9 | Comparative |
| | | | | | | Example |
| P-4 | 0.2 | Dissolved | 2 | 5 | 0.9 | Example |
| P-5 | 0.2 | Dissolved | 20 | 5 | 0.1 | Example |
| P-6 | 0.2 | Dissolved | 25 | 5 | 0.5 | Example |
| P-7 | 0.2 | Dissolved | 30 | 5 | 0.6 | Example |
| P-8 | 0.2 | Dissolved | 48 | 5 | 0.8 | Example |
| P-9 | 0.3 | Dissolved | 70 | 23 | 32 | Comparative |
| | | | | | | Example |
| P-10 | 3.0 | Particulate | 22 | 73 | 0.9 | Comparative |
| | | | | | | Example |
| P-11 | 0.2 | Dissolved | 20 | 5 | 0.9 | Comparative |
| | | | | | | Example |
| P-12 | 0.2 | Dissolved | 25 | 7 | 0.8 | Example |
| P-13 | 0.2 | Dissolved | 25 | 9 | 18 | Comparative |
| | | | | | | Example |
| P-14 | 0.2 | Dissolved | 0 | 0 | 0.8 | Comparative |
| | | | | | | Example |
| P-15 | 0.4 | Dissolved | 28 | 0 | 0.1 | Example |
| P-16 | 0.1 | Dissolved | 23 | 8 | 0.1 | Example |
| P-17 | 0.2 | Dissolved | 23 | 7 | 0.7 | Example |
| P-18 | 0.1 | Dissolved | 21 | 5 | 0.1 | Example |
| P-19 | — | — | — | — | 12 | Comparative |
| | | | | | | Example |
| P-20 | 1.1 | Dissolved | 30 | 55 | 0.7 | Example |
| P-21 | 0.2 | Dissolved | 15 | 5 | 0.5 | Example |
| P-22 | 0.1 | Dissolved | 30 | 5 | 0.3 | Example |
| P-23 | 0.1 | Dissolved | 30 | 5 | 2.0 | Comparative |
| | | | | | | Example |
| P-24 | 0.1 | Dissolved | 45 | 5 | 0.7 | Example |

TABLE 3-1

| | | | | | | | Binder solution or | | | Dispersion | |
|---|---|---|---|---|---|---|---|---|---|---|---|
| | Positive electrode | | Inorganic solid | | Conductive auxiliary | | dispersion liquid | | | medium (D) | |
| Composition | active material (AC) | | electrolyte (SE) | | agent (CA) | | | SP | | | SP |
| No. | Kind | Content | Kind | Content | Kind | Content | No. | value | Content | Kind | value |
| N-1 | Si | 50 | LPS | 45 | AB | 4 | B-1 | 18.9 | 1 | Xylene | 18.7 |
| N-2 | Si | 50 | LPS | 45 | AB | 4 | B-2 | 17.8 | 1 | Xylene | 18.7 |
| N-3 | Si | 50 | LPS | 45 | AB | 4 | B-3 | 12.0 | 1 | Xylene | 18.7 |
| N-4 | Si | 50 | LPS | 45 | AB | 4 | B-4 | 18.9 | 1 | Xylene | 18.7 |
| N-5 | Si | 50 | LPS | 45 | AB | 4 | B-5 | 18.9 | 1 | Xylene | 18.7 |
| N-6 | Si | 50 | LPS | 45 | AB | 1 | B-6 | 18.9 | 1 | Xylene | 18.7 |
| N-7 | Si | 50 | LPS | 45 | AB | 4 | B-7 | 18.9 | 1 | Xylene | 18.7 |
| N-8 | Si | 50 | LPS | 45 | AB | 4 | B-8 | 18.9 | 1 | Xylene | 18.7 |
| N-9 | Si | 50 | LPS | 45 | AB | 4 | B-9 | 19.0 | 1 | Xylene | 18.7 |
| N-10 | Si | 50 | LPS | 45 | AB | 4 | B-10 | 21.7 | 1 | Xylene | 18.7 |
| N-11 | Si | 50 | LPS | 45 | AB | 4 | B-11 | 18.9 | 1 | Xylene | 18.7 |
| N-12 | Si | 50 | LPS | 45 | AB | 4 | B-12 | 18.9 | 1 | Xylene | 18.7 |
| N-13 | Si | 50 | LPS | 45 | AB | 4 | B-13 | 18.9 | 1 | Xylene | 18.7 |
| N-14 | Si | 50 | LPS | 45 | AB | 4 | B-14 | 18.9 | 1 | Xylene | 18.7 |
| N-15 | Si | 50 | LPS | 45 | AB | 4 | B-15 | 18.3 | 1 | Xylene | 18.7 |
| N-16 | Si | 50 | LPS | 45 | AB | 4 | B-16 | 18.6 | 1 | Xylene | 18.7 |
| N-17 | Si | 50 | LPS | 45 | AB | 4 | B-17 | 18.9 | 1 | Xylene | 18.7 |
| N-18 | Si | 50 | LPS | 45 | AB | 4 | B-18 | 18.6 | 1 | Xylene | 18.7 |
| N-19 | Si | 50 | LPS | 46 | AB | 4 | — | — | — | Xylene | 18.7 |
| N-20 | Si | 50 | LPS | 45 | AB | 4 | B-19 | 19.8 | 1 | Xylene | 18.7 |
| N-21 | Si | 50 | LPS | 45 | AB | 4 | B-20 | 18.9 | 1 | Xylene | 18.7 |
| N-22 | Si | 50 | LPS | 45 | AB2 | 4 | B-18 | 18.6 | 1 | Xylene | 18.7 |
| N-23 | Si | 50 | LPS | 45 | AB | 4 | B-21 | 18.8 | 1 | Xylene | 18.7 |
| N-24 | Si | 50 | LPS | 45 | CB | 4 | B-18 | 18.6 | 1 | Xylene | 18.7 |

TABLE 3-2

| | Difference | | Adsorption | Adsorption | Condition (4A) | |
|---|---|---|---|---|---|---|
| Composition | in SP | | rate | rate | Average particle | |
| No. | value | Solubility | [A_{CA}] | [A_{SE}] | diameter | Note |
| N-1 | 0.2 | Dissolved | 0 | 0 | 0.9 | Comparative |
| | | | | | | Example |
| N-2 | 0.9 | Dissolved | 55 | 0 | 28 | Comparative |
| | | | | | | Example |
| N-3 | 6.7 | Dissolved | 0 | 0 | 0.9 | Comparative |
| | | | | | | Example |
| N-4 | 0.2 | Dissolved | 2 | 5 | 0.9 | Example |
| N-5 | 0.2 | Dissolved | 20 | 5 | 0.1 | Example |
| N-6 | 0.2 | Dissolved | 25 | 5 | 0.5 | Example |
| N-7 | 0.2 | Dissolved | 30 | 5 | 0.6 | Example |
| N-8 | 0.2 | Dissolved | 48 | 5 | 0.8 | Example |
| N-9 | 0.3 | Dissolved | 70 | 23 | 32 | Comparative |
| | | | | | | Example |
| N-10 | 3.0 | Particulate | 22 | 73 | 0.9 | Comparative |
| | | | | | | Example |
| N-11 | 0.2 | Dissolved | 20 | 5 | 0.9 | Comparative |
| | | | | | | Example |
| N-12 | 0.2 | Dissolved | 25 | 7 | 0.8 | Example |
| N-13 | 0.2 | Dissolved | 25 | 9 | 18 | Comparative |
| | | | | | | Example |
| N-14 | 0.2 | Dissolved | 0 | 0 | 0.8 | Comparative |
| | | | | | | Example |
| N-15 | 0.4 | Dissolved | 28 | 0 | 0.1 | Example |
| N-16 | 0.1 | Dissolved | 23 | 8 | 0.1 | Example |
| N-17 | 0.2 | Dissolved | 23 | 7 | 0.7 | Example |
| N-18 | 0.1 | Dissolved | 21 | 5 | 0.1 | Example |
| N-19 | — | — | — | — | 12 | Comparative |
| | | | | | | Example |
| N-20 | 1.1 | Dissolved | 30 | 55 | 0.7 | Example |
| N-21 | 0.2 | Dissolved | 15 | 5 | 0.5 | Example |
| N-22 | 0.1 | Dissolved | 30 | 5 | 0.3 | Example |
| N-23 | 0.1 | Dissolved | 30 | 5 | 2.0 | Comparative |
| | | | | | | Example |
| N-24 | 0.1 | Dissolved | 45 | 5 | 0.7 | Example |

<Abbreviations in table>
NMC: LiNi_{1/3}Co_{1/3}Mn_{1/3}O₂ (manufactured by Sigma-Aldrich Co., LLC, particle diameter: 5 μm)
LPS: LPS synthesized in Synthesis Example S
AB: Acetylene black (manufactured by Denka Company Limited, particle diameter: 35 nm, bulk density: 0.04 g/ml)
AB2: Acetylene black (manufactured by Denka Company Limited, particle diameter: 48 nm, bulk density: 0.15 g/ml)
CB: Carbon black SUPER-P Li (manufactured by IMERYS S.A., particle diameter: 40 nm)
Si: Silicon (manufactured by Kojundo Chemical Laboratory, Co., Ltd., particle diameter: 5 μm)
Xylene: A mixture of xylene isomers in which the mixing molar ratio between isomers is, ortho-isomer:para-isomer:meta-isomer = 1:5:2.

<Production of Positive Electrode Sheet for all-Solid State Secondary Battery>

Each of the positive electrode compositions P-1 to P-24 obtained as above was applied onto an aluminum foil having a thickness of 20 μm at room temperature by using a baker type applicator (product name: SA-201, manufactured by Tester Sangyo Co., Ltd.), followed by heating at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets P-1 to P-24 for an all-solid state secondary battery, having a positive electrode active material layer having a film thickness of 100 μm.

<Production of Negative Electrode Sheet for all-Solid State Secondary Battery>

Each of the negative electrode compositions N-1 to N-24 obtained as above was applied onto a copper foil having a thickness of 20 μm at room temperature by using a baker type applicator (product name: SA-201), followed by heating at 110° C. and subsequently drying and heating at 110° C. for 2 hours with a vacuum dryer AVO-200NS (product name, manufactured by AS ONE Corporation) to dry (to remove the dispersion medium) the negative electrode composition. Then, using a heat press machine, the dried negative electrode composition was pressurized (10 MPa, 1 minute) at 25° C. to produce each of negative electrode sheets N-1 to N-24 for an all-solid state secondary battery, having a negative electrode active material layer having a film thickness of 70 μm.

The following evaluations were carried out for each of the manufactured compositions and each of the sheets, and the results are shown in Table 4-1 to Table 4-2 (collectively referred to as Table 4).

<Evaluation 1: Dispersion Stability>

Each of the prepared compositions (slurries) was put into a glass test tube having a diameter of 10 mm and a height of 4 cm up to a height of 4 cm and allowed to stand at 25° C. for 24 hours. The solid content reduction rate for the upper 25% (in terms of height) of the composition before and after standing was calculated from the following expression. The ease of aggregation or sedimentation of the solid particles due to a lapse of time was evaluated as the storage stability (the dispersion stability) of the composition by determining where the solid content reduction rate is included in any one of the following evaluation standards. In this test, the smaller the solid content reduction rate is, the more excellent the dispersion stability is, and an evaluation standard “F” or higher is the pass level.

Solid content reduction rate (%)=[(concentration of solid contents of upper 25% before standing-concentration of solid contents of upper 25% after standing)/concentration of solid contents of upper 25% before standing]×100

—Evaluation Standards—

A: Solid content reduction rate<0.5%

B: 0.5%≤solid content reduction rate<2%

C: 2%≤solid content reduction rate<5%

D: 5%≤solid content reduction rate<10%

E: 10%≤solid content reduction rate<15%

F: 15%≤solid content reduction rate<20%

G: 20%≤solid content reduction rate

<Evaluation 2: Upper Limit Concentration for Slurrying>

In the preparation of each of the above-described compositions (slurries), the blending amount of each of the dispersion media was adjusted to prepare a test composition having a concentration of solid contents of 76% by mass in the composition. The prepared test composition having a concentration of solid contents of 76% by mass was placed in a container (a columnar container (diameter: 5.0 cm, height: 7.0 cm) for a self-rotation type mixer (ARE-310: product name, manufactured by THINKY CORPORATION) placed on a desk, to a height of about 1.0 cm, and then tilted by 60 degrees (with respect to the vertical direction) from this state, and it was checked whether or not the fluidity was such a degree that the prepared composition dripped (undergo variation) under the weight thereof within 10 seconds. In a case where the test composition did not drip (did not move) under the weight thereof and had no fluidity, the dispersion medium was added so that the concentration of solid contents of the test composition was reduced by 1% by mass, the test composition was dispersed at 2,000 rpm for 1 minute with the above-described self-rotation type mixer, and then it was checked whether or not the test composition had fluidity in the same manner as in the case of the above-described test composition having a concentration of solid contents of 76% by mass. This operation was repeated so that the concentration of solid contents was reduced by 1% by mass per operation, and the maximum concentration of the concentrated slurry capable of being prepared was evaluated regarding the maximum concentration of solid contents having fluidity as the upper limit concentration for slurrying. This test was carried out in an environment of 25° C.

In a case where the concentration of solid contents is increased to a concentration exceeding the upper limit concentration for slurrying, it is difficult to be used in the application (coating) step in the first place. Therefore, the upper limit concentration for slurrying is an indicator of the upper limit concentration of solid contents of the composition that can be used in the coating step, and it is preferable to be high.

In Table 4 below, the unit of the upper limit concentration for slurrying is omitted, the unit of which is % by mass.

<Evaluation 3: Average Particle Diameter of Conductive Auxiliary Agent in Active Material Layer>

The average particle diameter of the conductive auxiliary agent in the active material layer in the produced positive electrode sheet for an all-solid state secondary battery and the produced negative electrode sheet for an all-solid state secondary battery were measured as follows, and the results are shown in Table 4. In Table 4, the unit of the average particle diameter is omitted, the unit of which is “m”.

That is, a cut surface obtained by cutting the active material layer of each produced sheet in the vertical direction was observed with a scanning electron microscope (SEM) at a magnification of 5,000 times to obtain an SEM image. In a region of 0.1 mm×0.05 mm in the SEM image, 50 single particles or aggregates of the conductive auxiliary agent were randomly selected to determine the area equivalent diameter of each conductive auxiliary agent, and the arithmetic average value thereof was used as the average particle diameter of the conductive auxiliary agent (CA) present in the active material layer.

The boundary of the particles of the conductive auxiliary agent (CA) in the SEM image can be identified by binarization. It is noted that in a case where the conductive auxiliary agent (CA) forms aggregates, each of the aggregates is regarded as one particle.

<Evaluation 4: Electron Conductivity of Active Material Layer>

The electron conductivity in the active material layer in the produced positive electrode sheet for an all-solid state secondary battery and the produced negative electrode sheet for an all-solid state secondary battery were measured as follows, and the results are shown in Table 4. In Table 4, the unit of the electron conductivity is omitted, the unit of which is mS/cm.

That is, each of the electrode sheets for an all-solid state secondary battery was punched out into a disk shape having a diameter of 10 mm and was placed in a cylinder made of PET having an inner diameter of 10 mm. A 10 mm SUS rod was inserted from both end openings of the cylinder, and the collector side and the active material layer side of the electrode sheet for an all-solid state secondary battery were pressurized by applying a pressure of 350 MPa with a SUS rod and then fixed in a state where a pressure of 50 MPa was applied. A constant voltage measurement was carried out using an impedance analyzer (VMP-300, manufactured by TOYO Corporation), a current value I (mA) in a case where a voltage of a voltage V=5.0 mV was applied was read, and the electron conductivity aₑ (mS/cm) was calculated according to the following expression. It is noted that the layer thickness of the active material layer was denoted as D (m). It is noted that the layer thickness D of the positive electrode active material layer was 90 μm, and the layer thickness D of the negative electrode active material layer was 65 μm.

σₑ(mS/cm)=I/V/0.0785×D

TABLE 4-1

| | | Upper limit | Positive electrode active material layer | | |
|---|---|---|---|---|---|
| | Dispersion | concentration of | Average particle | Electron | |
| No. | stability | slurry | diameter | conductivity | Note |
| P-1 | G | 53 | 0.9 | 8 | Comparative |
| | | | | | Example |
| P-2 | G | 51 | 28 | 7 | Comparative |
| | | | | | Example |
| P-3 | G | 52 | 0.9 | 9 | Comparative |
| | | | | | Example |
| P-4 | E | 57 | 0.9 | 20 | Example |
| P-5 | B | 68 | 0.1 | 50 | Example |
| P-6 | A | 75 | 0.5 | 45 | Example |
| P-7 | A | 75 | 0.6 | 45 | Example |
| P-8 | C | 64 | 0.8 | 18 | Example |
| P-9 | G | 56 | 32 | 5 | Comparative |
| | | | | | Example |
| P-10 | G | 55 | 0.9 | 7 | Comparative |
| | | | | | Example |
| P-11 | G | 53 | 0.9 | 9 | Comparative |
| | | | | | Example |
| P-12 | D | 62 | 0.8 | 12 | Example |
| P-13 | G | 53 | 18 | 6 | Comparative |
| | | | | | Example |
| P-14 | G | 53 | 0.8 | 8 | Comparative |
| | | | | | Example |
| P-15 | A | 75 | 0.1 | 49 | Example |
| P-16 | A | 75 | 0.1 | 48 | Example |
| P-17 | B | 69 | 0.7 | 30 | Example |
| P-18 | A | 75 | 0.1 | 49 | Example |
| P-19 | G | 50 | 12 | 5 | Comparative |
| | | | | | Example |
| P-20 | E | 57 | 0.7 | 20 | Example |
| P-21 | C | 65 | 0.5 | 35 | Example |
| P-22 | A | 75 | 0.3 | 60 | Example |
| P-23 | G | 56 | 2.0 | 9 | Comparative |
| | | | | | Example |
| P-24 | A | 70 | 0.7 | 30 | Example |

TABLE 4-2

| | | Upper | Positive electrode | | |
|---|---|---|---|---|---|
| | | limit | active material layer | | |
| | Dis- | con- | Average | | |
| | persion | centration | particle | Electron | |
| No. | stability | of slurry | diameter | conductivity | Note |
| N-1 | G | 51 | 0.9 | 8 | Comparative |
| | | | | | Example |
| N-2 | G | 51 | 28 | 7 | Comparative |
| | | | | | Example |
| N-3 | G | 51 | 0.9 | 9 | Comparative |
| | | | | | Example |
| N-4 | E | 55 | 0.9 | 20 | Example |
| N-5 | B | 68 | 0.1 | 50 | Example |
| N-6 | A | 72 | 0.5 | 45 | Example |
| N-7 | A | 72 | 0.6 | 45 | Example |
| N-8 | C | 65 | 0.8 | 18 | Example |
| N-9 | G | 52 | 32 | 5 | Comparative |
| | | | | | Example |
| N-10 | G | 55 | 0.9 | 7 | Comparative |
| | | | | | Example |
| N-11 | G | 52 | 0.9 | 9 | Comparative |
| | | | | | Example |
| N-12 | D | 61 | 0.8 | 12 | Example |
| N-13 | G | 53 | 18 | 6 | Comparative |
| | | | | | Example |
| N-14 | G | 52 | 0.8 | 8 | Comparative |
| | | | | | Example |
| N-15 | A | 73 | 0.1 | 49 | Example |
| N-16 | A | 73 | 0.1 | 48 | Example |
| N-17 | B | 67 | 0.7 | 30 | Example |
| N-18 | A | 73 | 0.1 | 49 | Example |
| N-19 | G | 49 | 12 | 5 | Comparative |
| | | | | | Example |
| N-20 | E | 55 | 0.7 | 20 | Example |
| N-21 | C | 64 | 0.5 | 35 | Example |
| N-22 | A | 73 | 0.3 | 60 | Example |
| N-23 | G | 55 | 2.0 | 9 | Comparative |
| | | | | | Example |
| N-24 | A | 70 | 0.7 | 30 | Example |

<Manufacturing of all-Solid State Secondary Battery>

A positive electrode sheet for an all-solid state secondary battery, a solid electrolyte sheet for an all-solid state secondary battery, and a negative electrode sheet for an all-solid state secondary battery were used in combinations of the constitutional layers shown in Table 5-1 and Table 5-2 (collectively referred to as Table 5) to manufacture all-solid state secondary battery.

(Preparation of Inorganic Solid Electrolyte-Containing Composition (Slurry)

2.8 g of the LPS synthesized in Synthesis Example S, 0.08 g (in terms of solid content mass) of B-1 as a polymer binder, and the butyl butyrate as the dispersion medium shown in the table below were put into a container for a self-rotation type mixer (ARE-310, manufactured by THINKY CORPORATION) so that the content of the dispersion medium in the composition was 50% by mass. Then, this container was set in a self-rotation type mixer ARE-310 (product name). Mixing was carried out under the conditions of 25° C. and a rotation speed of 2,000 rpm for 5 minutes to prepare an inorganic solid electrolyte-containing composition (slurry)S-1.

The contents of the respective components in the composition were 97.2% by mass for LPS and 2.8% by mass for the binder in 100% by mass of the solid content.

(Production of Solid Electrolyte Sheet for all-Solid State Secondary Battery)

Using a baker type applicator (product name: SA-201, manufactured by Tester Sangyo Co., Ltd.), the inorganic solid electrolyte-containing composition S-1 obtained as above was applied on an aluminum foil having a thickness of 20 μm, and heating was carried out at 110° C. for 2 hours to dry (remove the dispersion medium) the inorganic solid electrolyte-containing composition. Then, using a heat press machine, the inorganic solid electrolyte-containing composition dried at 25° C., and a pressure of 10 MPa for 10 seconds was pressurized to produce a solid electrolyte sheet S-1 for an all-solid state secondary battery. The film thickness of the solid electrolyte layer was 50 μm.

(Manufacture of all-Solid State Secondary Battery)

The positive electrode sheet for an all-solid state secondary battery, shown in the column of “Positive electrode sheet No.” in Table 5 was punched out into a disk shape having a diameter of 10 mm and was placed in a cylinder made of PET having an inner diameter of 10 mm. The solid electrolyte sheet S-1 for an all-solid state secondary battery was punched on the positive electrode active material layer side in the cylinder into a disk shape having a diameter of 10 mm and placed in the cylinder, and a 10 mm SUS rod was inserted from the openings at both ends of the cylinder (here, the positive electrode active material layer of the positive electrode sheet for an all-solid state secondary battery is in contact with the solid electrolyte layer of the solid electrolyte sheet S-1). The collector side of the positive electrode sheet for an all-solid state secondary battery and the aluminum foil side of the solid electrolyte sheet for an all-solid state secondary battery were pressurized by applying a pressure of 350 MPa with an SUS rod. The SUS rod on the side of the solid electrolyte sheet for an all-solid state secondary battery was once removed to gently peel off the aluminum foil of the solid electrolyte sheet for an all-solid state secondary battery, and then the negative electrode sheet for an all-solid state secondary battery, shown in the column of “Negative electrode sheet No.” in Table 5, was punched out into a disk shape having a diameter of 10 mm and inserted onto the solid electrolyte layer of the solid electrolyte sheet for an all-solid state secondary battery in the cylinder (here, the solid electrolyte layer of the solid electrolyte sheet S-1 is in contact with the negative electrode active material layer of the negative electrode sheet for an all-solid state secondary battery). The removed SUS rod was inserted again into the cylinder and the sheets were fixed while applying a pressure of 50 MPa. In this way, all-solid state secondary battery Nos. C-1 to C-48 having a lamination configuration of an aluminum foil (thickness: 20 μm)—a positive electrode active material layer (thickness: 90 μm)—a solid electrolyte layer (thickness: 45 μm)—a negative electrode active material layer (thickness: 65 μm)—a copper foil (thickness: 20 μm) were obtained.

<Evaluation 5: Cycle Characteristics (Discharge Capacity Retention Rate) Test>

The discharge capacity retention rate of each of the manufactured all-solid state secondary batteries was measured using a charging and discharging evaluation device TOSCAT-3000 (product name, manufactured by Toyo System Corporation).

Specifically, each of the all-solid state secondary batteries was charged in an environment of 30° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the high-speed charging at a current density of 3.0 mA/cm² until the battery voltage reaches 3.6 V and the high-speed charging and discharging at a current density of 3.0 mA/cm² until the battery voltage reaches 2.5 V was set as one cycle, and this high-speed charging and discharging cycle was repeatedly carried out 500 cycles. The discharge capacity of each all-solid state secondary battery at the first cycle of the high-speed charging and discharging and the discharge capacity at the 500th cycle of the high-speed charging and discharging were measured with a charging and discharging evaluation device: TOSCAT-3000 (product name). The discharge capacity retention rate was determined according to the following expression, and this discharge capacity retention rate was applied to the following evaluation standards to evaluate the cycle characteristics of the all-solid state secondary battery. In this test, an evaluation standard of “F” or higher is the pass level. The results are shown in Table 5.

It is noted that although the all-solid state secondary batteries C-4 and C-23 were evaluated to correspond to an evaluation F, the discharge capacity retention rate was 68%.

Discharge capacity retention rate (%)=(discharge capacity at 500th cycle/discharge capacity at first cycle)×100

In this test, the higher the evaluation standard is, the better the battery performance (the cycle characteristics) is, and the initial battery performance can be maintained even in a case where a plurality of times of high-speed charging and discharging are repeated (even in a case of the long-term use).

All of the all-solid state secondary batteries for evaluation according to the embodiment of the present invention exhibited the discharge capacity values at the first cycle which are sufficient for functioning as an all-solid state secondary battery. Moreover, the all-solid state secondary battery for evaluation according to the embodiment of the present invention maintained excellent cycle characteristics even in a case where the general charging and discharging cycle was repeatedly carried out under the same conditions as those in the above-described initialization instead of those in the high-speed charging and discharging.

—Evaluation Standards—

A: 90%≤discharge capacity retention rate

B: 85%≤discharge capacity retention rate<90%

C: 80%≤discharge capacity retention rate<85%

D: 75%≤discharge capacity retention rate<80%

E: 70%≤discharge capacity retention rate<75%

F: 60%≤discharge capacity retention rate<70%

G: Discharge capacity retention rate<60%

TABLE 5-1

| | Positive electrode | Solid electrolyte | Negative electrode | Cycle | |
|---|---|---|---|---|---|
| Battery No. | sheet No. | laminated sheet No. | sheet No. | characteristics | Note |
| C-1 | P-1 | S-1 | N-1 | G | Comparative |
| | | | | | Example |
| C-2 | P-2 | S-1 | N-1 | G | Comparative |
| | | | | | Example |
| C-3 | P-3 | S-1 | N-1 | G | Comparative |
| | | | | | Example |
| C-4 | P-4 | S-1 | N-1 | F | Example |
| C-5 | P-5 | S-1 | N-1 | A | Example |
| C-6 | P-6 | S-1 | N-1 | B | Example |
| C-7 | P-7 | S-1 | N-1 | B | Example |
| C-8 | P-8 | S-1 | N-1 | C | Example |
| C-9 | P-9 | S-1 | N-1 | G | Comparative |
| | | | | | Example |
| C-10 | P-10 | S-1 | N-1 | G | Comparative |
| | | | | | Example |
| C-11 | P-11 | S-1 | N-1 | G | Comparative |
| | | | | | Example |
| C-12 | P-12 | S-1 | N-1 | D | Example |
| C-13 | P-13 | S-1 | N-1 | G | Comparative |
| | | | | | Example |
| C-14 | P-14 | S-1 | N-1 | G | Comparative |
| | | | | | Example |
| C-15 | P-15 | S-1 | N-1 | A | Example |
| C-16 | P-16 | S-1 | N-1 | A | Example |
| C-17 | P-17 | S-1 | N-1 | B | Example |
| C-18 | P-18 | S-1 | N-1 | A | Example |
| C-19 | P-19 | S-1 | N-1 | G | Comparative |
| | | | | | Example |
| C-39 | P-20 | S-1 | N-1 | E | Example |
| C-40 | P-21 | S-1 | N-1 | B | Example |
| C-41 | P-22 | S-1 | N-1 | A | Example |
| C-42 | P-23 | S-1 | N-1 | G | Comparative |
| | | | | | Example |
| C-43 | P-24 | S-1 | N-1 | B | Example |

TABLE 5-2

| | Positive electrode | Solid electrolyte | Negative electrode | Cycle | |
|---|---|---|---|---|---|
| Battery No. | sheet No. | laminated sheet No. | sheet No. | characteristics | Note |
| C-20 | P-1 | S-1 | N-1 | G | Comparative |
| | | | | | Example |
| C-21 | P-1 | S-1 | N-2 | G | Comparative |
| | | | | | Example |
| C-22 | P-1 | S-1 | N-3 | G | Comparative |
| | | | | | Example |
| C-23 | P-1 | S-1 | N-4 | F | Example |
| C-24 | P-1 | S-1 | N-5 | A | Example |
| C-25 | P-1 | S-1 | N-6 | B | Example |
| C-26 | P-1 | S-1 | N-7 | B | Example |
| C-27 | P-1 | S-1 | N-8 | C | Example |
| C-28 | P-1 | S-1 | N-9 | G | Comparative |
| | | | | | Example |
| C-29 | P-1 | S-1 | N-10 | G | Comparative |
| | | | | | Example |
| C-30 | P-1 | S-1 | N-11 | G | Comparative |
| | | | | | Example |
| C-31 | P-1 | S-1 | N-12 | D | Example |
| C-32 | P-1 | S-1 | N-13 | G | Comparative |
| | | | | | Example |
| C-33 | P-1 | S-1 | N-14 | G | Comparative |
| | | | | | Example |
| C-34 | P-1 | S-1 | N-15 | A | Example |
| C-35 | P-1 | S-1 | N-16 | A | Example |
| C-36 | P-1 | S-1 | N-17 | B | Example |
| C-37 | P-1 | S-1 | N-18 | A | Example |
| C-38 | P-1 | S-1 | N-19 | G | Comparative |
| | | | | | Example |
| C-44 | P-1 | S-1 | N-20 | E | Example |
| C-45 | P-1 | S-1 | N-21 | B | Example |
| C-46 | P-1 | S-1 | N-22 | A | Example |
| C-47 | P-1 | S-1 | N-23 | G | Comparative |
| | | | | | Example |
| C-48 | P-1 | S-1 | N-24 | B | Example |

The following findings can be seen from the results of Table 4 and Table 5.

The storage stability is not sufficient in any one of the electrode compositions P-19 and N-19 which do not contain the component defined in the present invention or the electrode compositions which do not satisfy any of the conditions (1) to (4) defined in the present invention. As a result, in the active material layers formed of these compositions, the average particle diameter of the conductive auxiliary agent is too large or the electron conductivity is insufficient, and thus it is not possible to manufacture an all-solid state secondary battery having excellent cycle characteristics.

On the other hand, any one of the electrode compositions which contain the inorganic solid electrolyte (SE), the active material (AC), the conductive auxiliary agent (CA), the dispersion medium (D), and the polymer binder (B) and which satisfy the conditions (1) to (4) exhibits excellent dispersion stability even in a case where the concentration of solid contents is increased. The active material layer using each of these electrode compositions contains a conductive auxiliary agent having a small particle diameter and exhibits a high electron conductivity, and thus an all-solid state secondary battery including this active material layer has low resistance and makes it possible to realize excellent cycle characteristics.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery

What is claimed is:

1. An electrode composition comprising:
an inorganic solid electrolyte (SE) having an ion conductivity of a metal belonging to Group 1 or Group 2 of the periodic table;
an active material (AC);
a conductive auxiliary agent (CA);
a polymer binder (B); and
a dispersion medium (D),
wherein the electrode composition satisfies the following conditions (1) to (4),
(1) the polymer binder (B) is dissolved in the dispersion medium (D),
(2) in the dispersion medium (D), an adsorption rate [A_{CA}] of the polymer binder (B) with respect to the conductive auxiliary agent (CA) is more than 0% and 50% or less,
(3) a mass average molecular weight of a polymer that constitutes the polymer binder (B) is 6,000 or more, and
(4) an average particle diameter of the conductive auxiliary agent (CA) that is present in an active material layer formed of the electrode composition is less than 1.0 μm.

2. The electrode composition according to claim 1,
wherein the adsorption rate [A_{CA}] is 5% or more and less than 30%.

3. The electrode composition according to claim 1,
wherein in the dispersion medium (D), an adsorption rate [A_{SE}] of the polymer binder (B) with respect to the inorganic solid electrolyte (SE) is 45% or less.

4. The electrode composition according to claim 1,
wherein the mass average molecular weight is 10,000 to 700,000.

5. The electrode composition according to claim 1,
wherein a difference ΔSP between an SP value of the dispersion medium (D) and an SP value of the polymer that constitutes the polymer binder (B) is 3.0 MPa^{1/2} or less.

6. The electrode composition according to claim 1,
wherein the polymer that forms the polymer binder (B) contains a constitutional component having a functional group selected from the following group (a) of functional groups,
<Group (a) of functional groups>
a hydroxy group, an amino group, a carboxy group, a sulfo group, a phosphate group, a phosphonate group, a sulfanyl group, an ether bond, an imino group, an ester bond, an amide bond, a urethane bond, a urea bond, a heterocyclic group, an aryl group, and a carboxylic acid anhydride group.

7. The electrode composition according to claim 1,
wherein the inorganic solid electrolyte (SE) is a sulfide-based inorganic solid electrolyte.

8. An electrode sheet for an all-solid state secondary battery, comprising:
an active material layer formed of the electrode composition according to claim 1.

9. The electrode sheet for an all-solid state secondary battery according to claim 8, wherein an average particle diameter of the conductive auxiliary agent (CA) in the active material layer is 0.5 μm or less.

10. The electrode sheet for an all-solid state secondary battery according to claim 8, wherein an electron conductivity of the active material layer is 30 mS/cm or more.

11. An all-solid state secondary battery comprising, in the following order:
a positive electrode active material layer;
a solid electrolyte layer; and
a negative electrode active material layer,
wherein at least one layer of the positive electrode active material layer or the negative electrode active material layer is an active material layer formed of the electrode composition according to claim 1.

12. A manufacturing method for an electrode sheet for an all-solid state secondary battery, the manufacturing method comprising:
forming a film of the electrode composition according to claim 1.

13. A manufacturing method for an all-solid state secondary battery, the manufacturing method comprising:
manufacturing an all-solid state secondary battery through the manufacturing method according to claim 12.
